(19) United States
(12) Patent Application Publication
(10) Pub. No.: US 2025/0332607 A1
(43) Pub. Date: Oct. 30, 2025

(54) ACOUSTICAL STREAMING

(71) Applicant: Kohler Co., Kohler, WI (US)

(72) Inventors: William C. Kuru, Plymouth, WI (US); Jason M. Kwacz, Kohler, WI (US); Prasanth Jayakumar, Prune (IN)

(21) Appl. No.: 19/189,906

(22) Filed: Apr. 25, 2025

Related U.S. Application Data
(60) Provisional application No. 63/640,033, filed on Apr. 29, 2024.

(51) Int. Cl. B05B 17/06; E03D 9/00

(52) U.S. Cl. CPC B05B 17/0653; E03D 9/00

(57) ABSTRACT

An apparatus includes a dispenser configured to dispense a fluid and an array configured to emit a plurality of acoustic waves, the acoustic waves generating a flow of air toward a target. The flow of air is configured to convey the fluid to the target. The collective wavefronts of the acoustic waves may be symmetrical around a propagating axis along which the flow of air is generated.

### CROSS-REFERENCE TO RELATED APPLICATION

This application claims priority benefit of Provisional Application No. 63/640,033 (Attorney Docket No, 010222-22068A) filed on Apr. 29, 2024, which is hereby incorporated by reference in its entirety.

### FIELD

The present disclosure relates to generally to acoustical streaming. More specifically, the present disclosure relates to conveying fluids or aerosols using acoustic waves.

### BACKGROUND

Generally, aerosols and gasses are moved through air using pressurized nozzles or spray heads. However, pressurized nozzles and spray heads are significantly limited in their ability to move aerosols and gasses substantial distances through air. Specifically, pressurized nozzles and spray heads either completely lack the ability to move aerosols and gasses substantial distances through air or are highly inefficient, resulting in gross oversaturation and wetting of surfaces to which the aerosols and gasses are applied. Accordingly, there is a need for devices and systems capable of moving gasses and aerosols substantial distances through air without overspray or over saturation of a surface to which the aerosols and gasses are moved.

### BRIEF DESCRIPTION OF THE DRAWINGS

Objects, features, and advantages of the present disclosure should become more apparent upon reading the following detailed description in conjunction with the drawing figures, in which:

FIG. 1 illustrates an ultrasound array in accordance with one example of the present disclosure.

FIG. 2 illustrates an ultrasound array in accordance with another example of the present disclosure.

FIG. 3 illustrates a side cross sectional view of the ultrasound array of FIG. 2 in accordance with an example of the present disclosure.

FIG. 4 illustrates an ultrasound array in accordance with yet another example of the present disclosure.

FIG. 5 illustrates a side view of an ultrasound array in accordance with still another example of the present disclosure.

FIG. 6 illustrates a front view of the ultrasound array of FIG. 5 in accordance with one example of the present disclosure.

FIG. 7 illustrates a tuning brick in accordance with one example of the present disclosure.

FIG. 8 illustrates a side cross sectional view of an ultrasound array and collective wavefronts emitted by the ultrasound array in accordance with one example of the present disclosure.

FIG. 9 illustrates a side cross sectional view of an ultrasound array and collective wavefronts emitted by the ultrasound array in accordance with one example of the present disclosure.

FIG. 10 illustrates a cross sectional distribution of acoustic energy emitted by an ultrasound array in accordance with one example of the present disclosure.

FIG. 11 illustrates an acoustic streaming device in accordance with one example of the present disclosure.

FIG. 12 illustrates an acoustic streaming device in accordance with another example of the present disclosure.

FIG. 13 illustrates an acoustic streaming device in accordance with still another example of the present disclosure.

FIG. 14 illustrates a toilet in accordance with one example of the present disclosure.

FIG. 15 illustrates a toilet in accordance with one example of the present disclosure.

FIG. 16 illustrates an acoustic streaming device in accordance with still another example of the present disclosure.

FIG. 17 illustrates an acoustic streaming device in accordance with still another example of the present disclosure.

FIG. 18 illustrates an acoustic streaming device in accordance with still another example of the present disclosure.

FIG. 19 illustrates an acoustic streaming device in accordance with still another example of the present disclosure.

FIG. 20 illustrates an acoustic streaming device in accordance with still another example of the present disclosure.

FIG. 21 illustrates an acoustic streaming device in accordance with still another example of the present disclosure.

FIG. 22 illustrates an acoustic streaming device in accordance with still another example of the present disclosure.

FIG. 23 illustrates an acoustic streaming device in accordance with still another example of the present disclosure.

FIG. 24 illustrates a flow chart for operating a streaming device in accordance with one example of the present disclosure.

FIG. 25 illustrates a flow chart for operating a streaming device in accordance with another example of the present disclosure.

FIG. 26 illustrates an apparatus for controlling a streaming device in accordance with one example of the present disclosure.

### DETAILED DESCRIPTION

Described herein are devices, systems, and methods for conveying a gas or aerosol using acoustic waves. According to the present disclosure, acoustic energy emitted from an array of sound sources may be concentrated around a propagating axis along which a three-dimensional streaming beam or cylindrical, linear flow of air is generated. The streaming beam generated by the array of sound sources may be used to convey gasses and/or aerosols. Specifically, the streaming beam may extend between the array of sound sources and a target to which a fluid (e.g., gasses and/or aerosols) is conveyed by the streaming beam or from which aerosols are conveyed (e.g., to be collected) by the streaming beam.

According to some examples of the present disclosure, an orientation of the streaming beam may be changed such that a fluid may be conveyed to a large surface. For example, an orientation of the streaming beam may be changed such that a fluid may be conveyed to the entirety of a target surface or object (e.g., having an area larger than a cross-sectional area of the streaming beam), to different target surfaces and/or objects, and/or to target surfaces and/or objects that move. Similarly, an orientation of the streaming beam may be changed such that aerosols may be conveyed from (e.g., and subsequently collected): an entirety of a target surface, object, or area; different target surfaces, objects, or areas; and/or a target object or surface that moves.

According to some examples of the present disclosure, as described hereinafter in greater detail, an orientation of the streaming beam may be changed by shifting or adjusting the phase angle or phase of an acoustic wave emitted from one or more (e.g., each) of the sound sources included in the array. Additionally, according to some examples of the present disclosure, as described hereinafter in greater detail, an array of sound sources may be configured to generate streaming beams that flow toward and/or away from the array.

The devices, systems, and methods described herein may be used to convey fluids (e.g., gasses and aerosols) in a wide variety of different applications. Specifically, the devices, systems, and methods described herein may be used to convey a wide variety of fluids to a wide variety of surfaces or objects. Similarly, the devices, systems, and methods described herein may collect aerosols in a wider variety of different environments.

According to some examples, the devices, systems, and methods described herein may be configured to dispense and convey a cleaning fluid to a target surface or object to clean or disinfect the target surface or object. Specifically, a streaming beam generated by a device or system of the present disclosure and/or according to a method of the present disclosure may accurately convey a fluid (e.g., cleaning fluid) to a distant target surface or object without oversaturating the target surface or object with fluid. According to some examples, the devices, systems, and methods described herein may be employed to convey a cleaning fluid or disinfectant to various surfaces or objects in a bathroom. For example, the devices, systems, and methods described herein may convey a cleaning fluid to a target surface or object including a surface or surfaces of a toilet, a toilet seat, a toilet actuator (e.g., flush lever or handle), a urinal, a urinal actuator, a shower or bath (e.g., floors, walls), a faucet, a faucet handle, a counter top, a dispenser (e.g., paper towel dispenser, other dispenser), a door handle (e.g., stall handle), and the like.

Although described above in connection with cleaning or disinfection of surfaces and objects disposed in a bathroom, the devices, systems, and methods described herein are not limited thereto. Specifically, the devices, systems, and methods described herein may be configured to convey a cleaning fluid to surfaces or objects in any environment. For example, the devices, systems, and methods described herein may be configured to convey a cleaning fluid to surfaces and objects disposed in a health care facility (e.g., hospital, doctor's office), kitchen or food preparation facility, a manufacturing facility (e.g., factory), and/or a laboratory.

According to other examples, the devices, systems, and methods described herein may be configured to dispense and convey an aerosolized scent, perfume, or essential oil to a target. Specifically, an aerosolized scent, perfume, or essential oil may be conveyed to a user and/or specific anatomy of a user (e.g., a face, neck, wrist, etc.) when the user or specific anatomy, respectively, is set as the target. According to some examples, as described hereinafter in greater detail, the devices, systems, and methods described herein may employ an image classifier configured to identify a user and/or a specific anatomy of the user, such that a scent, perfume, or essential oil may be dispensed and conveyed to the user and/or a specific anatomy of the user.

According to yet other examples, the devices, systems, and methods described herein may be configured to dispense and convey water vapor to a target. Specifically, in some examples, liquid water at an elevated temperature (e.g., supplied from a water heater or other hot water source) may be aerosolized, dispensed, and conveyed to a user and/or specific anatomy of a user (e.g., face). In other examples, liquid water at a relatively cool temperature (e.g., less than 98.6° F., less than 70° F.) may be aerosolized, dispensed, and conveyed to a user and/or specific anatomy of a user. As noted above, the devices, systems, and methods described herein may employ an image classifier configured to identify a user and/or a specific anatomy of the user. The image classifier may be configured to identify a user and/or specific anatomy of the user such that water vapor (e.g., at an elevated temperature, at a relatively cool temperature) may be dispensed and conveyed to the user and/or specific anatomy of the user.

According to still more examples of the present disclosure, the devices, systems, and methods described herein may be configured to dispense and convey a deodorant or air freshener to a target area, surface, or object. Specifically, the devices, systems, and methods described herein may be configured to dispense and convey a deodorant or air freshener to a target area, surface, or object disposed within a bathroom. For example, the devices, systems, and methods described herein may be configured to dispense and convey a deodorant or air freshener to an area (e.g., of a bathroom) proximate to a toilet and/or to one or more surfaces of the toilet or proximate to the toilet.

According to other examples, the devices, systems, and methods described herein may be configured to convey aerosols away from a specific area. Specifically, the devices, systems, and methods described herein may generate a streaming beam configured to convey aerosols away from a specific area (e.g., an area surrounding a toilet) within a bathroom. According to some examples, as described hereinafter in greater detail, the devices, systems, and methods described herein may make use of a collector (e.g., a target) to which aerosols are conveyed by the streaming beam. Additionally, according to some examples, as described hereinafter in greater detail, the devices, systems, and methods described herein may be employed in conjunction with operation of another plumbing fixture included in a bathroom. For example, the devices, systems, and methods described herein may be operated in conjunction with (e.g., during, following) flushing of a toilet, so as to collect aerosols emitted when the toilet is flushed. The devices, systems, and methods described herein may be configured to collect odor causing aerosols and/or pathogens.

Described above are just a few of the wide variety of applications in which the devices, systems, and methods described herein may be used.

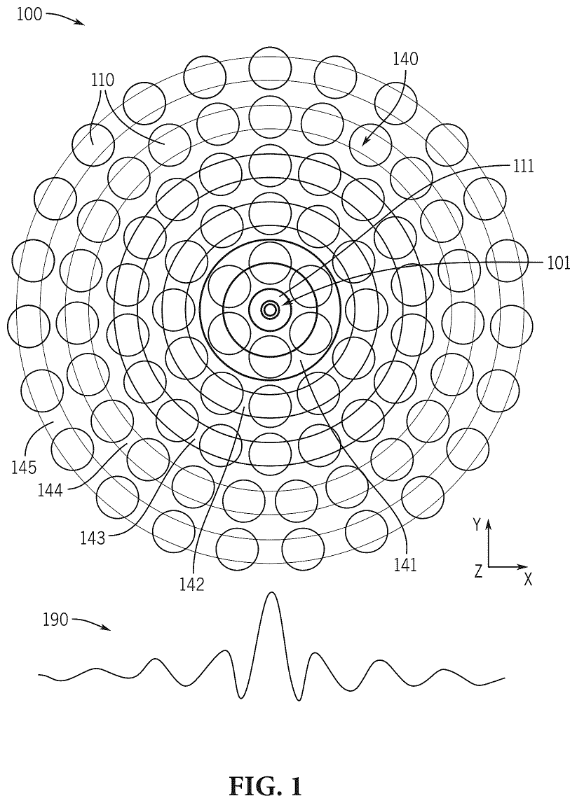

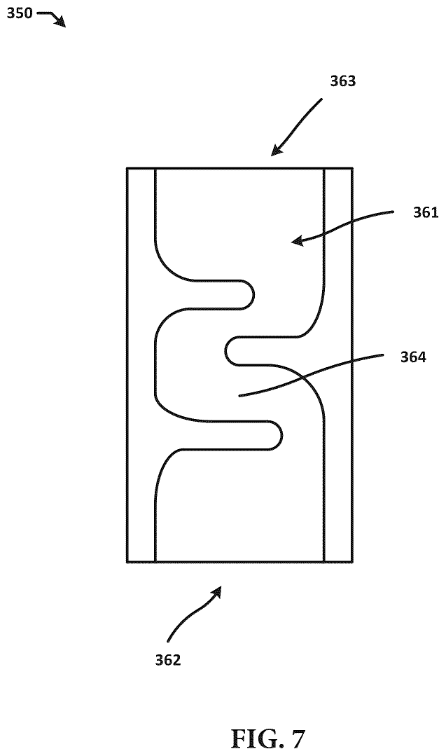

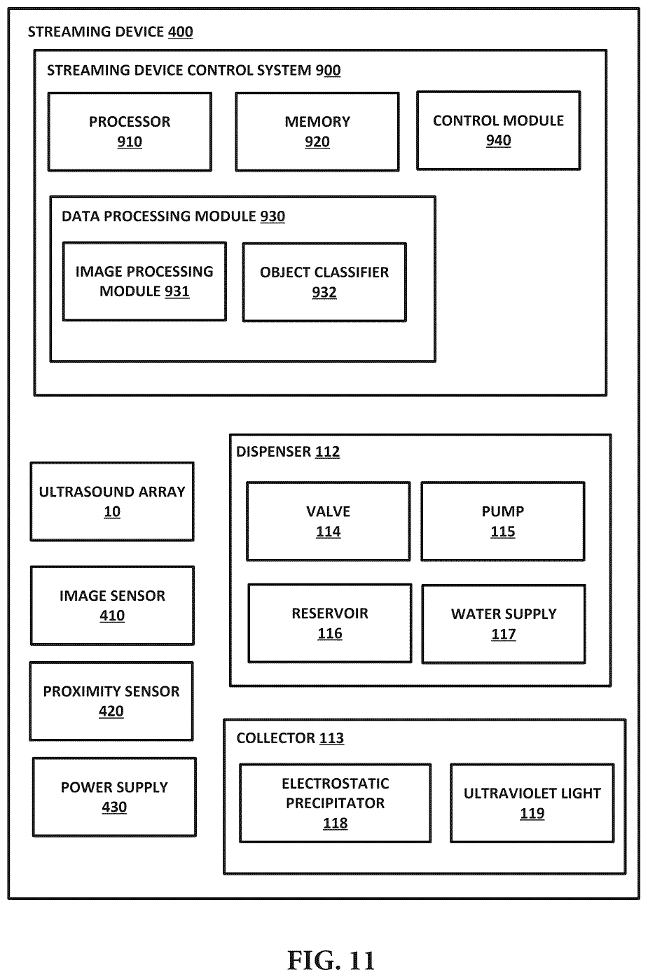

Referring generally to FIGS. 1-7, several arrays of sound sources or ultrasound arrays 100, 200, 300, 350 are illustrated in accordance with examples of the present disclosure. The acoustic streaming devices or streaming devices described hereinafter with respect to FIGS. 11-13 and 16-23 may each include one of the ultrasound arrays 100, 200, 300, 350. Each of the ultrasound arrays 100, 200, 300, 350 may be configured to generate a streaming beam or cylindrical, linear flow of air using acoustic (e.g., ultrasonic) waves. Each of the ultrasound arrays 100, 200, 300, 350 may include one or more (e.g., a plurality of) ultrasound transducers 110 configured to generate an ultrasound wave.

According to the present disclosure, an ultrasound wave may be an acoustic wave having a frequency greater than 20 kilohertz (kHz). The ultrasound transducers 110 according to the present disclosure may be configured to generate ultrasound waves having any frequency. For example, each ultrasound transducer 110 may produce an ultrasound wave having a frequency in the range of 20 kHz to 200 kHz, in the range of 20 kHz to 100 kHz, in the range of 20 kHz to 60 kHz, or in the range of 30 kHz to 50 kHz. According to some examples of the present disclosure, the ultrasound transducers 110 may be configured to produce an ultrasound wave having a frequency of 40 kHz. According to some examples, each of the ultrasound transducers 110 may emit an ultrasound wave having the same frequency, wavelength, and/or amplitude.

As noted above, each of the ultrasound arrays 100, 200, 300, 350 may include one or more (e.g., a plurality of) ultrasound transducers 110. Each of the ultrasound arrays 100, 200, 300, 350 may include any number of ultrasound transducers 110. For example, each ultrasound array 100, 200, 300, 350 may include in the range of 1-1000 ultrasound transducers 110, in the range of 1-500 ultrasound transducers 110, in the range of 1-100 ultrasound transducers 110, in the range of 50-100 ultrasound transducers 110, or any other number of ultrasound transducers 110.

According to the present disclosure, an ultrasound array 100, 200, 300, 350 is configured to generate a streaming beam or a linear flow of air using acoustic or ultrasonic waves produced thereby. In some examples, the streaming beam may have a linear, cylindrical shape. According to the present disclosure, a streaming beam generated by one of the ultrasound arrays 100, 200, 300, 350 may be configured to convey a fluid (e.g., a gas and/or an aerosol). As noted above and described in greater detail hereinafter, a streaming beam generated by one of the ultrasound arrays 100, 200, 300, 350 described herein may convey a fluid to a target and/or convey aerosols away from a target.

According to some examples of the present disclosure, the ultrasound arrays 100, 200, 300, 350 may generate a streaming beam by concentrating acoustic energy emitted by the respective ultrasound array 100, 200, 300, 350 around a propagating axis along which a streaming beam or linear flow of air may be generated. Specifically, acoustic energy emitted by the ultrasound array 100, 200, 300, 350 may be concentrated such that a three-dimensional pressure formation in which kinetic energy provided by the acoustic waves (e.g., ultrasound field) accelerates air, producing a streaming beam or linear flow of air.

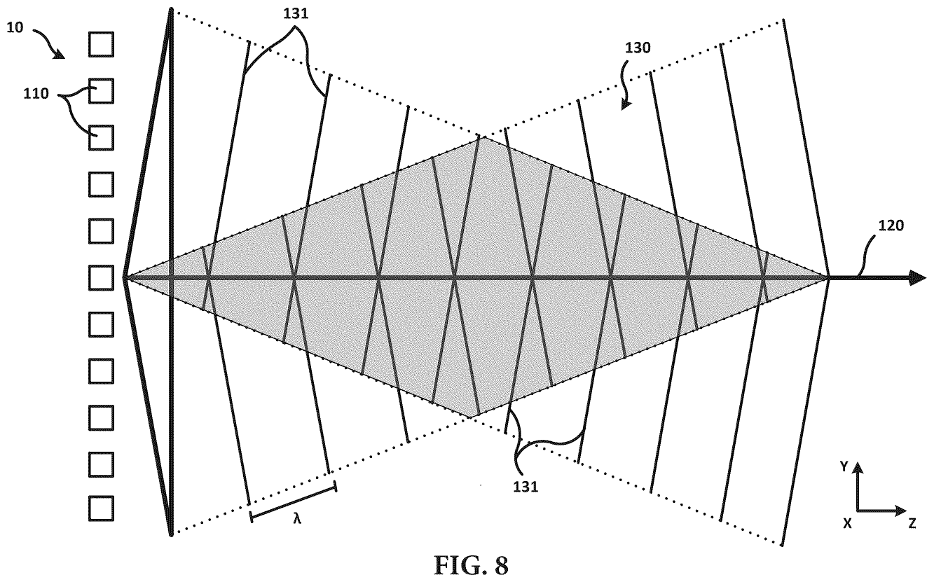

Referring to FIG. 8, a side cross sectional view of an ultrasound array 10 is illustrated in accordance with one example of the present disclosure. The ultrasound array 10 may be any of the ultrasound arrays 100, 200, 300, 350 described herein. Specifically, FIG. 8 illustrates an ultrasound array 10, a propagating axis 120 along which a streaming beam may be formed, and a wavefront diagram 130 illustrating collective wavefronts 131 emitted by the ultrasound array 10 which may be used to generate a streaming beam along the propagating axis 120. Specifically, the wavefront diagram 130 illustrates collective wavefronts 131 of the ultrasound waves emitted by all of sound sources or ultrasound transducers 110 included in the ultrasound array 10. As noted above, the ultrasound array 10 may be configured to concentrate acoustic energy around the propagating axis 120, such that a flow of air is generated along the propagating axis 120. Specifically, the superposition of the collective wavefronts 131 at the propagating axis 120 may generate the three-dimensional flow of air or streaming beam (along the propagating axis 120). Specifically, the ultrasound array 10 may be configured to concentrate acoustic energy provided by the ultrasound waves emitted by each of the ultrasound transducers 110 about the propagating axis 120.

According to the present disclosure, the ultrasound array 10 may be configured emit ultrasound waves or an ultrasound field, such that the collective wavefronts 131 of ultrasound waves emitted by (e.g., all of the ultrasound transducers 110 included in) the ultrasound array 10 are symmetrical around the propagating axis 120. The ultrasound array 10 may be configured to emit ultrasound waves or an ultrasound field, such that collective wavefronts 131 of the ultrasound array 10 form a three-dimensional acoustical beam (e.g., streaming beam). According to some examples, the phase angle or phase an ultrasound wave emitted by the each of the plurality of ultrasound transducers 110 may be shifted (e.g., by shifting a control or ultrasound signal provided to the ultrasound transducer 110), such that the collective wavefronts 131 representing all of the locations in a medium (e.g., air) where the ultrasound waves emitted by the arrayed ultrasound transducers 110 are in the same phase (e.g., crest, trough) are symmetrical around the propagating axis 120. In other words, the phase of an ultrasound wave emitted by each ultrasound transducer 110 individually or the ultrasound transducers 110 in groups may be shifted virtually or electronically to imitate a three-dimensional (e.g., cone shaped) sound source. As illustrated in FIG. 8, the ultrasound array 10 may be configured to emit collective wavefronts 131 (e.g., locations at which the collective ultrasound waves emitted by the ultrasound array 10 are in the same phase) which are symmetrical around the propagating axis 120. Specifically, the ultrasound array 10 may be concentrate acoustic energy around the propagating axis 120 by emitting ultrasonic waves having collective wavefronts 131 which are symmetrical about the propagating axis 120, such that a streaming beam is generated along the propagating axis 120.

Specifically, the ultrasound array 10 may be configured to emit ultrasound waves having collective wavefronts 131 which are symmetrical around the propagating axis, such that constructive interference occurs at the propagating axis, increasing the amplitude of an ultrasonic wave at the propagating axis 120 and thus increasing acoustic energy at the propagating axis. According to some examples, the phase or phase angle of the ultrasound waves emitted by each of the ultrasound transducers 110 include in the ultrasound array 10 may change as a distance between the ultrasound transducer 110 and the center of the ultrasound array 10 changes (e.g., as the ultrasound transducer 110 moves radially outward from a center of the ultrasound array), such that the collective wavefronts 131 emitted by the ultrasound array 10 are symmetrical around the propagating axis 120.

The ultrasound array 10 may generate ultrasound waves having collective wavefronts 131 that are symmetrical around a propagating axis 120. According to some examples, as described hereinafter in greater detail, the ultrasound arrays 100 and 300 may generate ultrasound waves having collective wavefronts 131 which are symmetrical around the propagating axis 120 by shifting the phase of an ultrasound wave emitted from each of the ultrasound transducers 110. Specifically, according to some examples of the present disclosure, the magnitude of a shift in phase (e.g., phase shift) of an ultrasound wave emitted from each of the ultrasound transducers 110 may be proportional to a distance between the ultrasound transducer 110 and a center 101 of the ultrasound array 100, 300. Specifically, in some examples, the magnitude of a shift in phase (e.g., phase shift) of an ultrasound wave emitted from each of the ultrasound transducers 110 may be proportional to a distance along a primary plane parallel to the primary axes (e.g., x-axis and y-axis) on which the ultrasound array 100, 300 is arranged. As described hereinafter in greater detail, the phase and thus the magnitude of a phase shift of an ultrasound wave emitted from each of the plurality of ultrasound transducers 110 may be shifted electronically, for example, by providing different control and/or ultrasound signals to different ultrasound transducers 110. Specifically, according to some examples, as described hereinafter with respect to FIG. 11, a streaming device control system 900 may control the phase and thus the magnitude of a phase shift of an ultrasound wave emitted from each of ultrasound transducers 110 using control and/or ultrasound signals provided to an ultrasound transducer 110.

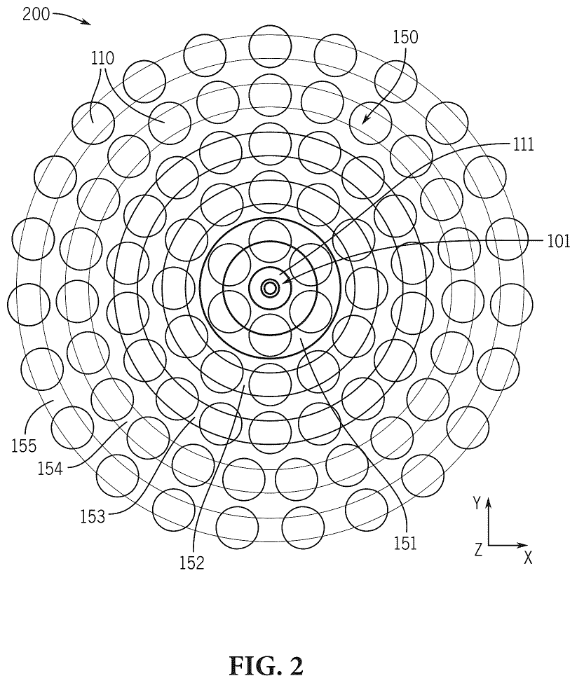

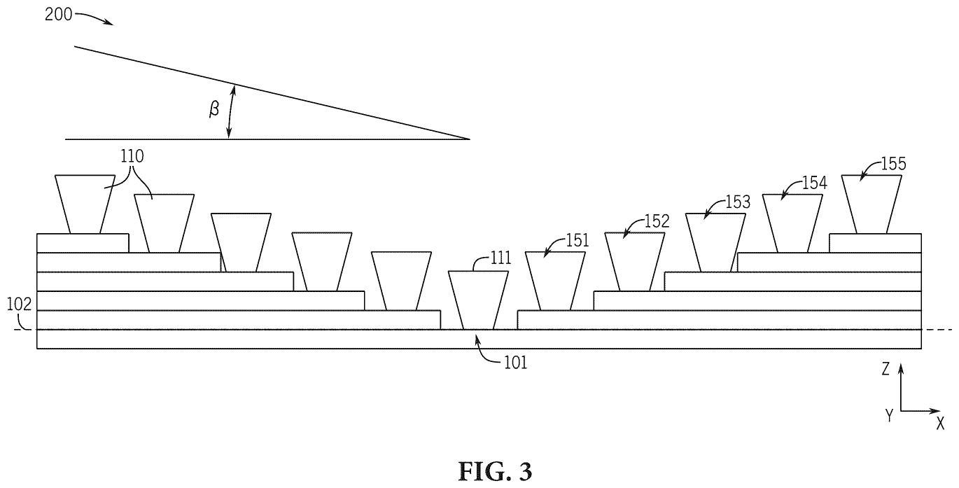

According to other examples of the present disclosure, as described below in greater detail with respect to FIGS. 2 and 3, an ultrasound array 200 may generate ultrasound waves having collective wavefronts 131 that are symmetrical around a propagating axis 120 by shifting or changing a position of the ultrasound transducers 110 along an axis (e.g., z-axis) perpendicular to a primary plane parallel to the primary axes (e.g., x-axis and y-axis) along which the ultrasound array 200 is arranged.

According to yet other examples, a plurality of tuning bricks 360 may be configured to control receive ultrasound waves emitted from one or more ultrasound transducer 110 and (e.g., individually, independently) control the phase of an ultrasound wave exiting each of the plurality of tuning bricks 360, such that collective wavefronts (e.g., 131) of the ultrasound waves exiting the plurality of tuning bricks 360 are symmetrical around a propagating axis (e.g., 120) along which a streaming beam is generated.

According to the present disclosure, an ultrasound array 10 may generate a streaming beam along the propagating axis around which acoustic energy is concentrated. Specifically, the ultrasound array 10 may be configured to generate ultrasound waves having collective wavefront 131 that is symmetrical around the propagating axis 120, such that acoustic energy is concentrated along the propagating axis 120 and thus a streaming beam is formed along the propagating axis 120.

According to some examples, as shown in FIG. 8, an ultrasound array 10 may be configured to generate a streaming beam along a propagating axis 120 which is perpendicular to the primary axes (e.g., x-axis and y-axis) along which the ultrasound array 10 is arranged. Thus, according to some examples, the ultrasound array 10 may generate a streaming beam having an orientation and a direction of flow or propagating angle that is perpendicular to the axes (e.g., x-axis and y-axis) along which the ultrasound array 10 is arranged; however, the present disclosure is not limited thereto.

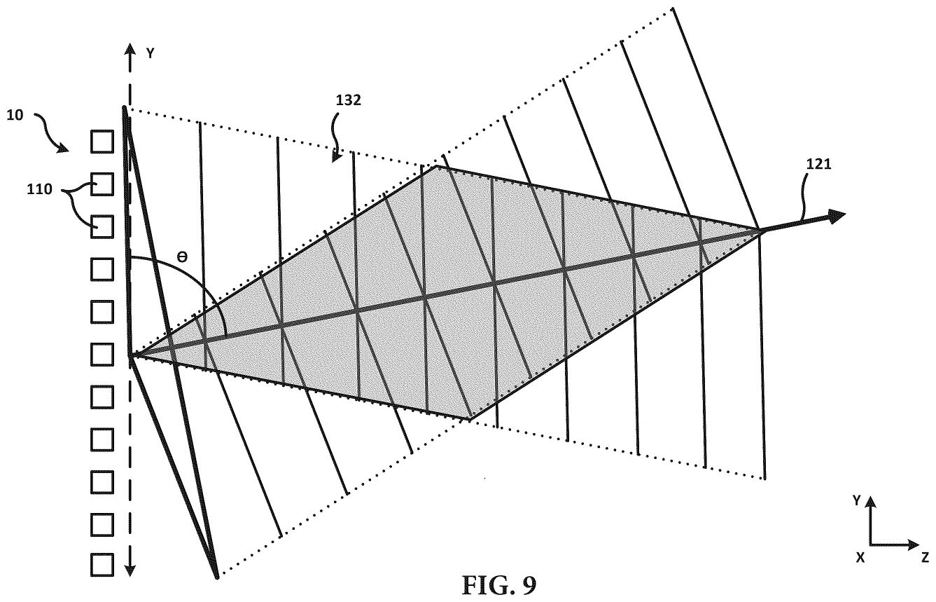

Specifically, in another example, as illustrated in FIG. 9, the ultrasound array 10 may be configured to emit ultrasound waves having collective wavefronts 131 as illustrated in the wavefront 132 which are symmetrical around a propagating axis 121 which may be disposed in any orientation or at any propagating angle θ (e.g., 0-90 degrees) with respect to a primary plane including the primary axes (e.g., x-axis, y-axis) along which the ultrasound array 10 is arranged. FIG. 9 illustrates a side view of the ultrasound array 10 and a propagating angle θ with respect to the primary plane. However, it is noted that the ultrasound array 10 may also be configured to emit ultrasound waves having collective wavefronts 131 which are symmetrical around a propagating axis 121 which is disposed in any orientation or at any propagating angle Δ (e.g., 0-360 degrees) with respect to a positive vertical axis when viewed from the front of the ultrasound array 10. Accordingly, acoustic energy may be concentrated along the propagating axis 121 and the ultrasound array 10 may generate a streaming beam along the propagating axis 121.

According to some examples, the ultrasound array 10 may be configured to selectively generate streaming beams along propagating axes having different orientations. Specifically, in some examples, the ultrasound array 10 may be configured to change an orientation of a propagating axis along which streaming beam is generated by shifting the phase of the ultrasound waves emitted by the ultrasound transducers 110 such that the collective wavefronts 131 (e.g., of ultrasound waves) emitted by the ultrasound array 10 are parallel around the selected or new propagating axis.

According to some examples of the present disclosure the orientation of a propagating axis along which a streaming beam may be selected by a user and/or a streaming device control system 900. For example, a user and/or the streaming device control system 900 may select and change the orientation of a propagating axis along which a streaming beam is generated that fluid is conveyed to or aerosols are conveyed from a target surface, object, or area. Specifically, a propagating axis may be selected so as to extend between the ultrasound array 10 and the target surface, object, or area.

According to some examples, when the orientation of a propagating axis is selected and/or changed the phase or the magnitude of a phase shift of an ultrasound wave emitted by each ultrasound transducer 110 may be determined (e.g., by streaming device control system 900) such that the collective wavefronts emitted by the ultrasound array 10 are symmetrical around the selected propagating axis and the ultrasound array may be controlled (e.g., by the streaming device control system 900) such that ultrasound waves having the determined phase or phase shift are emitted from each ultrasound transducer 110 such that a streaming beam is generated along the propagating axis.

As described hereinafter in greater detail, in some examples, the ultrasound array 10 may generate a streaming beam along a propagating axis that changes over time. Specifically, the ultrasound array 10 and/or a streaming device control system 900 may be configured to change the orientation of a propagating axis along which a collective wave front emitted by the ultrasound array 10 is symmetrical over time, such that, for example, fluid may be dispensed and continuously conveyed to a target object or surface having an area larger than a cross sectional area of the streaming beam and/or to a target that moves. According to some examples, the ultrasound array 10 and/or the streaming device control system 900 may generate a streaming beam along a propagating axis that changes over time, such that a fluid may be continuously conveyed to a target consisting of a specified path along which the streaming beam and propagating axis intersect an object as the streaming beam and propagating axis move over time.

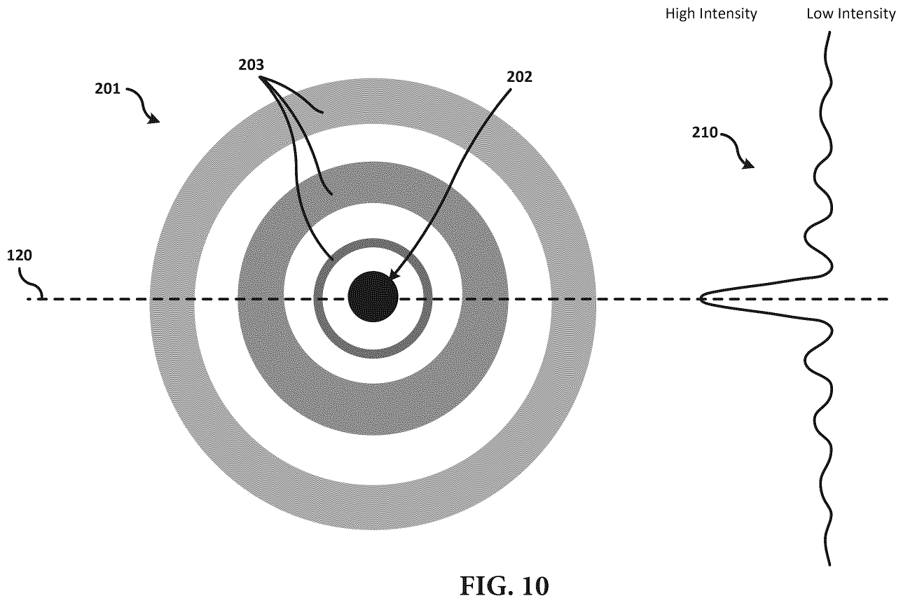

Referring to FIG. 10, a cross sectional distribution 201 of acoustic energy emitted by the ultrasound array 10 is illustrated in accordance with one example of the present disclosure. Specifically, FIG. 10 illustrates a cross sectional distribution 201 of acoustic energy emitted by the ultrasound array 10 when the ultrasound array 10 emits ultrasound waves having collective wavefronts 131 which are symmetrical around the propagating axis 120, as shown in FIG. 8, and thus the ultrasound array 10 generates a streaming beam along the propagating axis 120. As noted above, acoustic energy emitted from the ultrasound array 10 may be concentrated around the propagating axis 120 to create the three-dimensional pressure formation or energy distribution (e.g., density profile of sound energy) of which FIG. 10 provides a cross sectional view.

According to the present disclosure, a central portion 202 of the cross sectional energy distribution 201, disposed symmetrically around the propagating axis 120, may correspond to a portion of the energy distribution or density profile of sound energy having sufficient intensity to generate a flow of air. Specifically, the central portion 202 of the cross sectional energy distribution 201 which extends along the propagating axis 120 may form a linear density profile of sound energy having sufficient intensity to generate a flow of air. Accordingly, the ultrasound array 10 may be configured to generate a streaming beam in an area corresponding to the central portion 202 of the cross sectional energy distribution and extending along the propagating axis 120.

When a linear density profile of sound energy having sufficient energy is created, air disposed along the linear density profile may be accelerated by kinetic energy supplied from the ultrasound field, producing a linear flow of air. According to some examples of the present disclosure, where sinusoidal waves are used to generate a flow of air, a driving force per unit volume F is proportional to the acoustic intensity/and may be determined using Equation 1:

$$F = 2 \frac{∝}{ρ c} I \qquad Eq . 1$$

where ρ is the density of the medium, c is the sound velocity in the medium, a is a sound absorption coefficient. According to some examples, a streaming beam generated by the ultrasonic transducer array 10 may be a Bessel beam.

Additionally, FIG. 10 illustrates a graphical representation of acoustic intensity 210 emitted by the ultrasound array 10 in accordance with one example of the present disclosure. Specifically, FIG. 10 illustrates a graphical representation of acoustic intensity 210 emitted by the ultrasound array 10 when the ultrasound array 10 generates a streaming beam around the propagating axis 120. Specifically, FIG. 10 illustrates a graphical representation of acoustic intensity 210 corresponding in position to the cross sectional energy distribution 201. As shown in the graphical representation of acoustic intensity 210, acoustic energy emitted by the ultrasound array 10 may be concentrated so as to have a highest intensity in area corresponding to the central portion 202 of the cross sectional energy distribution 201 and the propagating axis 120. Further, as illustrated in the cross sectional energy distribution 201 and the graphical representation of acoustic intensity 210, acoustic energy may be concentrated in a plurality of bands 203 disposed radially around the central portion 202 (and propagating axis 120). As illustrated in FIG. 10, the acoustic intensity of each band 203 may decrease as a distance between the respective band 203 and the central portion 202 and/or propagating axis 120 increases.

According to the present disclosure, the ultrasound array 10 may be configured to selectively generate a streaming beam, for example a Bessel Beam, having a cylindrical, linear flow of air along a propagating along a center axis that either flows toward or away from the ultrasound array 10. Specifically, a direction in which a streaming beam flows, for example, toward or away from the ultrasound array 10 may be controlled by controlling the phase angles (e.g., crest, trough) of the individual transducers that create collective wavefronts 131 emitted by the ultrasound array 10 which are symmetrical around the propagating axis at the propagating axis (e.g., 120, 121). For example, if the crest of a collective wavefront 131 emitted by the ultrasound array 10 which is symmetrical about the propagating axis (e.g., 120, 121) is disposed at the propagating axis with a positive gradient in the phase angle (e.g., 120, 121) a flow away from the ultrasound array 100, 200, 300, 350 may be generated. Conversely, if a trough of a collective wavefront 131 emitted by the ultrasound array 10 which is symmetrical about the propagating axis (e.g., 120, 121) is disposed at the propagating axis with a negative gradient in the phase angle (e.g., 120, 121) a flow toward the ultrasound array 10 may be generated.

Returning to FIG. 1, an ultrasound array 100 is illustrated in accordance with one example of the present disclosure. As illustrated in FIG. 1, the ultrasound array 100 may have a circular shape. Specifically, the ultrasound array 100 may include a plurality of ultrasound transducers 110 arranged radially around a center 101 of the ultrasound array 100. As depicted in FIG. 1, the plurality of ultrasound transducers 110 may be arranged in multiple rings 140 disposed radially around the center 101 of the ultrasound array 100. According to some examples, each of the ultrasound transducers 110 included in the same ring 140 may be disposed the same distance away from the center 101 of the ultrasound array 100. Further, in some examples, the ultrasound array 100 may include a center transducer 111 (e.g., center ultrasound transducer) disposed at the center 101 of the ultrasound array 100 configured to emit an ultrasound wave.

According to some examples, all of the ultrasound transducers 110 included in the ultrasound array 100 may disposed on the same plane. For example, a back surface, emitting face, and/or center of the ultrasound transducers 110 may all be disposed on the same plane.

According to some examples, as illustrated in FIG. 1, the ultrasound array 100 may include five rings 140 of ultrasound transducers 110 disposed radially around the center 101 of the ultrasound array 100; however, the present disclosure is not limited thereto and may include any number of rings 140 of ultrasound transducers 110. Specifically, in some examples, as shown in FIG. 1, the ultrasound array 100 may include a first ring 141, a second ring 142, a third ring 143, a fourth ring 144, and a fifth ring 145 disposed sequentially from closest to furthest from the center 101 of the ultrasound array 100. According to some examples, as illustrated in FIG. 1, the number of ultrasound transducers 110 included in each ring 140 may increase as a distance between the respective ring 140 and the center 101 of the ultrasound array 100 increases. For example, a second ring 142 disposed further away from a center of the ultrasound array 100 than the first ring 141 may include more ultrasound transducers 110 than the first ring 141.

According to some examples, the ultrasound transducers 110 included in each ring 140 of the ultrasound array 100 may be grouped together and/or provided on the same channel such that the same control and/or ultrasound signals are provided to all of the ultrasound transducers 110 included in the respective ring 140.

Specifically, in some examples, referring to the ultrasound array 100 of FIG. 1, the ultrasound transducers included in the first ring 141 may be provided on a first channel, the ultrasound transducers 110 included in the second ring 142 may be provided on a second channel, the ultrasound transducers 110 included in the third ring 143 may be provided on a third channel, the ultrasound transducers 110 included in the fourth ring 144 may be provided on a fourth channel, and the ultrasound transducers 110 included in the fifth ring 145 may be provided on a fifth channel. According to some examples, where the ultrasound array 100 include a center transducer 111, the center transducer 111 may be provided on a sixth channel.

As noted above and described hereinafter in greater detail, in some examples, the phase of an ultrasonic wave emitted by an ultrasound transducer 110 may be controlled and/or shifted electronically. Specifically, the phase of an ultrasound wave emitted from an ultrasound transducer 110 may be controlled or shifted using one or more control and/or ultrasound signals provided (e.g., by the streaming device control system 900) to the ultrasound transducer 110.

According to some examples of the present disclosure, when the ultrasound transducers 110 included in each ring 140 are provided on the same channel and the same control signal(s) are provided to all of the ultrasound transducers 110 included in a respective ring 140, the ultrasound array 100 may be configured to generate a streaming beam along a propagating axis 120 which extends through a center 101 of the ultrasound array 100 and is perpendicular to the axes (e.g., x-axis and y-axis) along which the ultrasound array 100 is arranged. Specifically, a different control and/or ultrasound signal may be provided (e.g., by the streaming device control system 900) to the center ultrasound transducer 111 and the ultrasound transducers 110 included in each of the first ring 141, the second ring 142, the third ring 143, the fourth ring 144, and the fifth ring 145, such that collective wavefronts emitted by all of the ultrasound transducers 110 included in the ultrasound array 100 are symmetrical around a propagating axis 120.

Specifically, the ultrasound array 10 may be configured to generate a streaming beam along the propagating axis 120 when the same phase of an ultrasound wave is emitted from all of the ultrasound transducers included in a respective ring 140 (e.g., when the same control and/or ultrasound signals are provided to all of the ultrasound transducers 110 included in the respective ring 140) because all of the ultrasound transducers 110 included in a respective ring 140 may be arranged so as to be the same distance away from the center 101 of the ultrasound array 100. Accordingly, collective wavefronts of ultrasound waves emitted by all of the ultrasound transducers 110 included in a respective ring 140 of the ultrasound array 100 may be symmetrical around a propagating axis 120 extending through the center 101 of the ultrasound array and disposed perpendicular to the axes (e.g., x-axis and y-axis) along which the ultrasound array 100 is arranged when the same phase of an ultrasound wave is emitted from all of the ultrasound transducers 110 included in the respective ring 140. Accordingly, the phase of ultrasound waves emitted by the ultrasound transducers 110 in each ring 140 may be controlled or shifted, as opposed to individually controlling or shifting the phase of an ultrasound wave emitted from each ultrasound transducer 110, such that collective wavefronts 131 emitted by all of the ultrasound transducers included in the ultrasound array 100 are symmetrical around the propagating axis 120 and thus a streaming beam is generated along the propagating axis 120.

Additionally, FIG. 1 illustrates a graphical representation 190 of intensity of acoustic energy emitted by the ultrasound array 100 when a streaming beam is generated along an axis (e.g., z-axis) extending through a center of the ultrasound array 100 perpendicular to both of the axes (e.g., x-axis and y-axis) along which the ultrasound transducers 110 are arranged, as shown in FIG. 8.

According to another example, the phase or a shift in phase of an ultrasound wave emitted from each of the ultrasound transducers 110 included in the ultrasound array 100 may be individually determined and/or controlled (e.g., by the streaming device control system 900). According to some examples, the ultrasound array 100 may be configured to generate a streaming beam along a propagating axis, which is not perpendicular to both the axes (e.g., x-axis and y-axis) along which the ultrasound array 100 is arranged, by individually shifting the phase of an ultrasound wave emitted by each ultrasound transducer 110, for example, as opposed to controlling all of the ultrasound transducers 110 included in a respective ring 140 so as to emit the same phase of an ultrasound wave. According to some examples, individually controlling or shifting the phase of an ultrasound wave emitted by each ultra sound transducer 110 in the ultrasound array 100, while increasing complexity of the device or system, may provide for a greater degree of freedom as to the possible orientations of a propagating axis along which a streaming beam may be formed.

Returning to FIGS. 2 and 3, an ultrasound array 200 is illustrated in accordance with another example of the present disclosure. Specifically, FIG. 2 illustrates a front view of the ultrasound array 200 and FIG. 3 illustrates a side cross sectional view of the ultrasound array 200. Referring generally to FIGS. 2 and 3, according to some examples, the ultrasound array 200 may have a circular shape including a plurality of ultrasound transducers 110 arranged radially around a center 101 of the ultrasound array 200. Further, according to some examples, the ultrasound array 200 may include a plurality of ultrasound transducers 110 arranged in multiple rings 150 around the center 101 of the ultrasound array 200. According to some examples, all of the ultrasound transducers 110 included in the same ring 150 may be the same distance away from the center 101 of the ultrasound array 200. Further, in some examples, the ultrasound array 200 may include a center transducer 111 (e.g., center ultrasound transducer) disposed at the center 101 of the ultrasound array 200 configured to emit an ultrasound wave.

According to some examples, the ultrasound array 200 may include five rings 150 of ultrasounds transducers 110 disposed radially around the center 101 of the ultrasound array 200; however, the present disclosure is not limited thereto and may include any number of rings 150. For example, the ultrasound array 100 may include three rings 150 of ultrasound transducers 110, four rings 150 of ultrasound transducers 110, six rings 150 of ultrasounds transducers 110, seven rings 150 of ultrasound transducers 110, eight rings 150 of ultrasounds transducers 110, or any other number of rings 150 of ultrasound transducers 110.

Specifically, in some examples, as shown in FIGS. 2 and 3, the ultrasound array 200 may include five rings 150 of ultrasound transducers 110. Specifically, in some examples, the ultrasound array 200 may include a first ring 151, a second ring 152, a third ring 153, a fourth ring 154, and a fifth ring 155 disposed sequentially from closest to furthers from the center 101 of the ultrasound array 200. According to some examples, as illustrated in FIG. 2, the number of ultrasound transducers 110 included in each ring 150 may increase as a distance between the respective ring 150 and the center 101 of the ultrasound array 200 increases. For example, a second ring 152 disposed further away from a center of the ultrasound array 200 than the first ring 151 may include more ultrasound transducers 110 than the first ring 151.

According to some examples, as illustrated in FIGS. 2 and 3, one or more of the ultrasound transducers 110 included in the ultrasound array 200 may be offset from a primary plane 102 parallel to the primary axes (e.g., x-axis and y-axis) on which the ultrasound array 200 is arranged. The primary plane 102 may be a plane parallel to the primary axes (e.g., x-axis and y-axis) at a position (e.g., along the z-axis) corresponding to a center transducer 111, a dispenser 112, or a collector 113 disposed at the center of the ultrasound array 200 (see FIGS. 11-13 and description provided below for the dispenser 112 and collector 113). For example, the primary plane 102 may be disposed along a back surface, center, or front surface (e.g., emitting face) of the center transducer 111, dispenser 112, or collector 113.

According to some examples, the ultrasound transducers 110 included in one or more of the rings 150 of the ultrasound array 200 may be offset from the primary plane 102. According to some examples, the ultrasound transducers 110 included in each ring 150 may be offset from the primary plane 102. According to some examples, all of the ultrasound transducers 110 included in the ultrasound array 200 may be offset from the primary plane 102 a distance which is proportional to a distance along the primary plane 102 between the respective ultrasound transducer 110 and a center of the ultrasound array 200. Accordingly, because all the ultrasound transducers 110 included in each ring 140 may be disposed the same distance away from the center 101 of the ultrasound array 200, all of the ultrasound transducers 110 included in the respective ring 140 may be offset from the primary plane 102 the same distance (e.g., along the z-axis). According to some examples, the ultrasound transducers 110 included in each ring 150 may be offset different distances from the primary plane.

According to the present disclosure, the plurality of ultrasound transducers 110 may be offset from the primary plane 102, such that the ultrasound array 200 generates a streaming beam along a propagating axis 120 which extends through the center 101 of the ultrasound array 200 and is perpendicular to primary plane 102 when the same phase of an ultrasound wave is emitted from all of the ultrasound transducers 110 included in the ultrasound array. Specifically, the ultrasound transducers 110 may be offset from the primary plane 102 such that collective wavefronts 131 emitted by the ultrasound transducers 110 is symmetrical around the propagating axis 120 and thus the ultrasound array 200 generates a streaming beam without shifting the phase of any of the ultrasound waves emitted by the ultrasound transducers 110 included in the ultrasound array 200 (e.g., relative to the phase of an ultrasound wave emitted by another one of the ultrasound transducers 110). Accordingly, all of the ultrasound transducers 110 included in the ultrasound array 200 may be provided on the same channel and a streaming beam may be generated while providing (e.g., by the streaming device control system 900) the same control and/or ultrasound signals to all of the ultrasound transducers 110.

According to some examples, as noted above and illustrated in FIG. 3 the ultrasound transducers 110 may be offset from the primary plane 102 a distance which is proportional to a distance along the primary plane 102 between the center 101 of the ultrasound array 200. Specifically, in some examples the ultrasound transducers 110 in each ring 151-155 may be disposed linearly along an axis at an angle β with respect to the primary plane 102 extending radially around the ultrasound array 200 from the center 101 of the array 200. The angle β between the primary plane 102 and an axis along which the ultrasound transducers 110 are offset may vary. For example, the angle β may be in the range of 1-60 degrees, in the range of 1-45 degrees, in the range 1-30 degree, in the range of 3-30 degrees, in the range of 5-25 degrees, in the range of 7-20 degrees, or in the range of 10-15 degrees. The angle β between the primary plane 102 and the axis along which the ultrasound transducers 110 are offset may the depth or distance along which an acoustic streaming beam may extend. For example, a higher angle β may result in shallower streaming or the streaming beam extending along a shorter length of the propagating axis. Conversely, a smaller angle β may result in deeper streaming or the streaming beam extending along a longer length of the propagating axis.

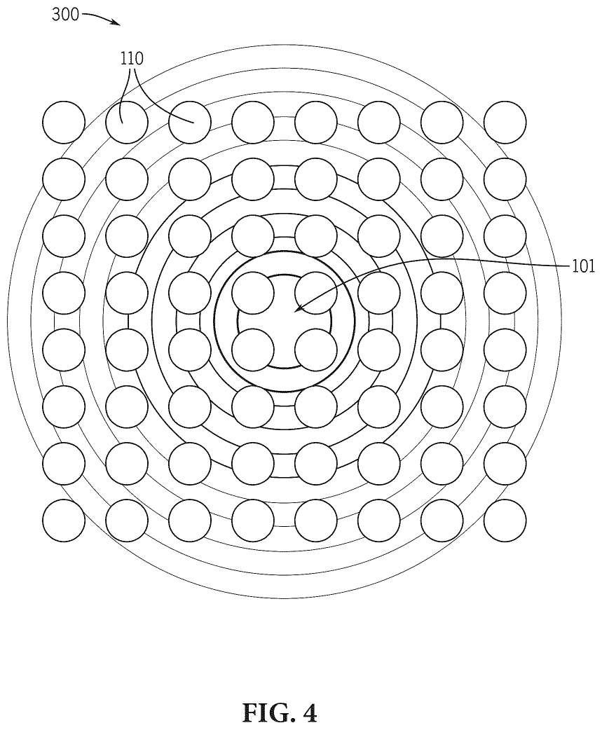

Referring to FIG. 4, an ultrasound array 300 is illustrated in accordance with one example of the present disclosure. According to some examples, the ultrasound array 300 may have a rectangular (e.g., square) shape including a plurality of ultrasound transducers 110 arranged in uniform rows and columns. In some examples, as illustrated in FIG. 4, each row and column may include the same number of ultrasound transducers 110. According to other examples, the ultrasound transducers 110 may be arranged to comprise an ultrasound array 300 having another shape, for example, a polygon shape having one, two, three, five, six, seven, eight, or more than eight sides. The ultrasound array 300 may include ultrasound transducers 110 arranged in any regular or irregular pattern and comprising an array having any shape. In some examples, the ultrasound transducers 110 may be arranged to comprise an ultrasound array 300 having an oblong or oval shape. According to some examples, as illustrated in FIG. 4, all of the ultrasound transducers 110 may be disposed on the same plane (e.g., parallel to the x-axis and the y-axis).

According to some examples, as illustrated in FIG. 4, each of the ultrasound transducers 110 may be provided on their own channel. Specifically, each of the ultrasound transducers 110 may be provided on their own channel, such that, control and/or ultrasound signals may be individually provided to each of the plurality of ultrasound transducers 110. Accordingly, as noted above and described hereinafter in greater detail control and/or ultrasound signals may be generated and provided (e.g., by the streaming device control system 900) to the ultrasound transducers 110 on an individual basis. Accordingly, the phase and/or the magnitude of a phase shift of an ultrasound wave emitted by each ultrasound transducer 110 may be individually or independently controlled (e.g., by the streaming device control system 900).

According to some examples, the ultrasound array 300 may be configured to generate a streaming beam along both a propagating axis (e.g., 120) which is perpendicular to the primary axes (e.g., x-axis and y-axis) along which the ultrasound array 300 is arranged and a propagating axis (e.g., 121) which is not perpendicular to the primary axes (e.g., x-axis and y-axis) along which the ultrasound array 300 is arranged.

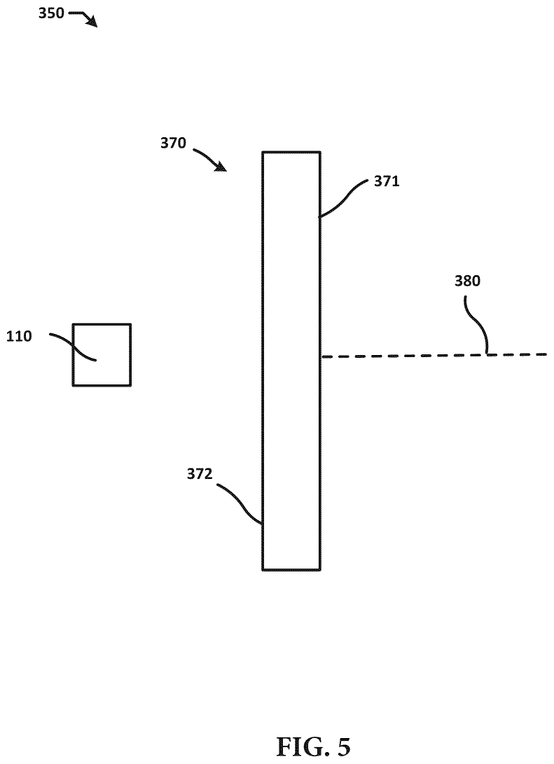

Referring generally to FIGS. 5-7 an ultrasound array 350 is illustrated in accordance with one example of the present disclosure. The ultrasound array 350 may include one or more sound source(s) or ultrasound transducer(s) 110, a plurality of tuning bricks 360, and a support structure 370. Each of the tuning bricks 360 may include a pathway 361 and be configured to control the magnitude of a shift in phase between an acoustic wave entering the pathway 361 and an acoustic wave exiting the pathway 361.

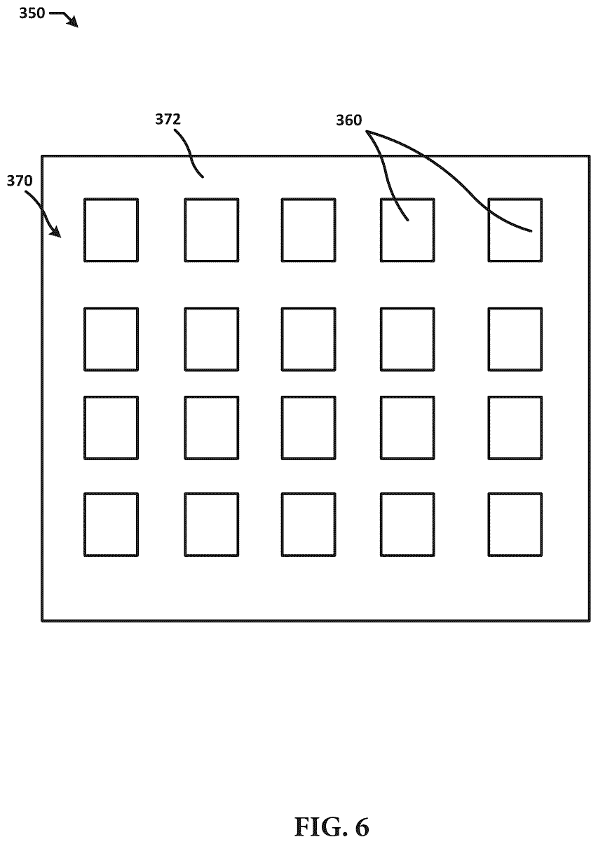

According to some examples, as illustrated in FIG. 6, the ultrasound array 350 may include a support structure 370 and a plurality of tuning bricks 360. The support structure 370 may have a generally rectangular cuboid shape including a front surface 371, a back surface 372, and a plurality of rectangular cuboid channels or cuboid channels extending between the front surface 371 and the back surface. According to some examples, the support structure 370 may have a lattice or grid layout 372 including cuboid channels extending therethrough in any regular or irregular pattern. According to some examples, as illustrated in FIG. 6, the cuboid channels may be provided in uniform rows and columns; each row and column may include the same number of cuboid channels. Each of the cuboid channels may be configured to receive and support a tuning brick 360. As illustrated in FIG. 6, a tuning brick 360 is disposed in each of the cuboid channels of the support structure 370.

According to some examples, a corresponding number of cuboid channels and tuning bricks 360 may be provided. The ultrasound array 350 may include any number of cuboid channels and/or tuning bricks 360. For example, the ultrasound array 350 may include in the range of 1-500 cuboid channels and/or tuning bricks 360, in the range of 1-250 cuboid channels and/or tuning bricks 360, in the range of 1-100 cuboid channels and/or tuning bricks 360, in the range of 1-50 cuboid channels and/or tuning bricks 360, in the range of 40-100 cuboid channels and/or tuning bricks 360.

Referring to FIG. 9, a tuning brick 360 is illustrated in accordance with one example of the present disclosure. According to some examples, as illustrated in FIG. 9, the tuning brick 360 may have a substantially rectangular cuboid shape. Further, as illustrated in FIG. 9, the tuning brick 360 may include a first end 362, a second end 363, and a channel or pathway 361 extending between the first end 362 and the second end 363. The first end 362 and the second end 363 may be disposed on opposite sides of the tuning brick 360. Specifically, in some examples, the first end 362 and the second end 363 may be the square sides of a tuning brick 360 having a rectangular cuboid shape. According to the present disclosure, the tuning brick 360, specifically, the pathway 361 of the tuning brick 360 may be configured to control (e.g., the magnitude of) a (e.g., relative) shift or change in phase of an ultrasound wave exiting the tuning brick 360 (e.g., the channel 361) relative to the phase of the ultrasound wave entering the tuning brick 360 (e.g., the channel 361). According to the present disclosure, each of the pathways 361 may have a winding shape including one or more segments 364 that are disposed perpendicular to a straight line extending through and perpendicular to the first end 362 and the second end 363.

According to the present disclosure, the specific geometry of the pathway 361 extending through the tuning brick 360 may be designed in consideration of a desired or required difference in phase an ultrasound wave entering and exiting the pathway 361. Accordingly, the magnitude of a relative shift or difference in phase between an ultrasound wave entering and exiting the tuning brick 360 may be controlled by adjusting or changing the shape or geometry of the pathway 361. According to some examples, a plurality or array of tuning bricks 360, as illustrated in FIG. 6, may include two or more tuning bricks 360 configured to control the phase of ultrasound waves such that the magnitude of a difference in phase between the ultrasound waves entering and exiting the respective tuning bricks 360 is different. The plurality or array of tuning bricks 360 may be configured to control the phase of the acoustic (e.g., ultrasound) waves exiting each tuning brick 360, such that, collective wavefronts of all of the acoustic waves exiting the tuning bricks 360 are symmetrical around a propagating axis along which a streaming beam or linear flow of air is generated.

Specifically, in some examples, as illustrated in the side view of the ultrasound array 350 of FIG. 5 in accordance with one example of the present disclosure, the ultrasound array 350 may include a single sound source or ultrasound transducer 110. According to some examples of the present disclosure, each of the plurality or array of tuning bricks 360 may receive an ultrasound wave emitted from the ultrasound transducer 110 at a first end 362 of a channel 361 of the respective tuning brick 360 disposed along a back side 372 of the support structure 370. Each of the tuning bricks 360 may control the magnitude of a shift in phase between the ultrasound wave entering the respective tuning brick 360 and exiting the respective tuning brick 360 at the second end 363 of the channel 361 disposed along the front side 371 of the support structure 370. Specifically, the plurality of tuning bricks 360 may control the phase of the ultrasound waves exiting the tuning bricks 360 such that collective wavefronts of the ultrasound waves exiting all of the plurality of the tuning bricks 360 are symmetrical about a propagating axis along which a streaming beam is generated.

According to other examples, the plurality or array of tuning bricks 360 may be configured to receive acoustic (e.g., ultrasound) waves from two or more sound sources or ultrasound transducers 110. The two or more sound sources or ultrasound transducers 110 may emit acoustic waves having the same phase. In these examples, the array of tuning bricks 360 may be configured to control the ultrasound waves exiting the tuning bricks 360 based on the phase of the ultrasound waves emitted by the two or more ultrasound transducers 110, such that collective wavefronts of the ultrasound waves exiting all of the plurality of the tuning bricks 360 are symmetrical about a propagating axis along which a streaming beam is generated.

According to some examples, each of the tuning bricks 360 may have a rectangular cuboid shape including a square base. According to some examples, the size or dimensions of the tuning brick 360 may be determined based on the wavelength of an acoustic wave shifted by the tuning brick 360 (e.g., the wavelength of an acoustic wave the tuning brick was designed to shift, the wavelength of an acoustic wave emitted by the ultrasound transducer(s) 110). For example, the square base of the tuning brick 360 may have sides having a length that is half of the wavelength of an acoustic wave the tuning brick is designed to shift or the wavelength of an ultrasound wave emitted by the ultrasound transducer(s) 110 included in the ultrasound array 350. Further, in some examples, the tuning brick 360 may have a height that is the same length of as an acoustic wave the tuning brick is designed to shift or the wavelength of an ultrasound wave emitted by the ultrasound transducer(s) 110 included in the ultrasound array 350.

According to some examples of the present disclosure, the tuning bricks 360 may be comprised of a metamaterial (e.g., a material having properties not found in naturally occurring materials). For example, a material comprising a tuning brick 360 may be designed to interact with (e.g., reflect, refract) ultrasound waves in a specific way or ways, so as to control the magnitude of a shift in phase or phase angle of ultrasound waves traveling therethrough. In some examples, all of the tuning bricks included in the ultrasound array 350 may be comprised of the same material (e.g., metamaterial). In other examples, two or more tuning bricks 360 included in the ultrasound array 350 may be comprised of different materials (e.g., metamaterials). In some examples, the tuning bricks 360 may be 3D printed.

Referring generally to FIGS. 11-13 acoustic streaming devices or streaming devices 400, 401, 402 are illustrated in accordance with several examples of the present disclosure.

Referring to FIG. 11, a streaming device 400 is illustrated in accordance with one example of the present disclosure. According to the present disclosure, the acoustic streaming device 400 may include an ultrasound array 10 and one or more of a dispenser 112 and a collector 113. As noted above, the ultrasound array 10 may be any of the ultrasound arrays 100, 200, 300, 350 described above with respect to FIGS. 1-7.

According to some examples, the streaming device 400 may include a streaming device control system 900 for controlling the streaming device 400. According to some examples, streaming device control system 900 may be included in (e.g., within a housing of) the streaming device 400. In other examples, the streaming device control system 900 may be disposed remotely or separately from the streaming device 400. The streaming device control system 900 may be used to control any of the acoustic streaming devices 400, 401, 402, 810, 820, 830, 840, 850, 860, 870, 880 described hereinafter with respect to FIGS. 11-13 and 16-24. Generally, the streaming device control system 900 is configured to control one or more of the ultrasound transducers 110 included in the ultrasound array 10, a dispenser 112, and a collector 113. As illustrated in FIG. 11, the streaming device control system 900 may include a processor 910 and memory 920. Further, the streaming device control system 900 may include a data processing module 930 and a control module 940. The data processing module 930 and control module 940 may be implemented using the processor 910 and/or memory 920. For example, the memory 920 may store one or more sets of rules or algorithms for controlling the streaming device (e.g., 400, 401, 402 810, 820, 830, 840, 850, 860, 870, 880) and the processor 910 may implement or execute the one or more sets of rules or algorithms.

The ultrasound array 10 may be configured generate a streaming beam or cylindrical, linear flow of air. According to some examples, the streaming device control system 900 may be provide power (e.g., electric current) and one or more control and/or ultrasound signals to the ultrasound array 10 causing the ultrasound array 10 to generate a streaming beam. According to some examples, the streaming device control system 900 may be configured to provide an ultrasound signal to one or more ultrasound transducers 110 included in the ultrasound array 10. Specifically, the processor 910 and/or control module 940 may be configured to provide an ultrasound signal to one or more ultrasound transducers 110 included in the ultrasound array 10.

The ultrasound signal may dictate or control one or more characteristics of an ultrasound wave emitted by an ultrasound transducer 110 to which it is provided. For example, an ultrasound signal may dictate or control a frequency, amplitude, and/or wavelength of an ultrasound wave emitted by an ultrasound transducer 110 to which the ultrasound signal is provided. Additionally, an ultrasound signal may dictate or control a phase (e.g., crest, trough, etc.) of an ultrasound wave emitted by an ultrasound transducer 110 to which the ultrasound signal is provided. Accordingly, two different ultrasound signals, provided to different ultrasound transducers 110, may be used to effectuate or implement a shift in phase (e.g., “phase shift”) between the ultrasound waves emitted from the respective ultrasound transducers 110.

According to some examples of the present disclosure, the processor 910 and/or control module 940 may be configured to send or provide the same ultrasound signal to all of the ultrasound transducers 110 included in the ultrasound array 10. For example, the ultrasound array 200, including ultrasound transducers 110 offset from a primary plane 102 along which the ultrasound array 200 is arranged, may generate a streaming beam when the same ultrasound signal is provided to all of the ultrasound transducers 110 included in the ultrasound array.

According to some examples of the present disclosure, the processor 910 and/or control module 940 may be configured to provide different ultrasound signals to different groups of ultrasound transducers 110. For example, the processor 910 and/or control module 940 be configured to send or provide a different ultrasound signal to each ring 141, 142, 143, 144, 145 of the ultrasound array 100. For example, the processor 910 and/or control module 940 may send or provide a different ultrasound signal to each channel of the ultrasound array 100. The ultrasound array 100 including rings 140 of ultrasound transducers 110 disposed the same distance away from the center 101 of the ultrasound array 100 may generate a streaming beam when a different ultrasound signal is sent or provided to each ring 140 of the ultrasound array 100.

According to some examples of the present disclosure, the processor 910 and/or control module 940 may be configured to send a different ultrasound signal to each ultrasound transducer 110 included in the ultrasound array 10. In other words, the phase of an ultrasound wave emitted from each ultrasound transducer 110 included in the ultrasound array 10 may be individually controlled by the streaming device control system 900. For example, the ultrasound array 300 may generate a streaming beam when a different ultrasound signal is provided to each of the ultrasound transducers 110 included in the ultrasound array 300.

According to some examples, streaming device control system 900 may be configured to change a direction of the streaming beam or cylindrical, linear flow of air generated by the ultrasound array 10. Specifically, the streaming device control system 900 may be configured to control whether a streaming beam flows, along a propagating axis, toward or away from the ultrasound array 10. For example, the processor 910 and/or control module 940 may control the ultrasound signal(s) sent to the ultrasound transducers 110 included in the ultrasound array 10, such that a different phase of the collective wavefronts which are symmetrical around the propagating axis is located at the propagating axis.

According to some examples, the streaming device control system 900 may be configured to change the orientation of a propagating axis along which a streaming beam is generated. Specifically, the streaming device control system 900 may change an orientation of a propagating axis along which a streaming beam is generated by shifting the phase of the ultrasound waves emitted from the ultrasound transducers 110 included in the ultrasound array 10, such that, the collective wavefronts emitted by the ultrasound array 10 are symmetrical about a selected propagating axis. For example, the processor 910 and/or control module 940 may provide ultrasound signals to the ultrasound transducers 110 included in the ultrasound array 10, such that the collective wavefronts of ultrasound waves emitted by the ultrasound array 10 are symmetrical around the selected propagating axis.

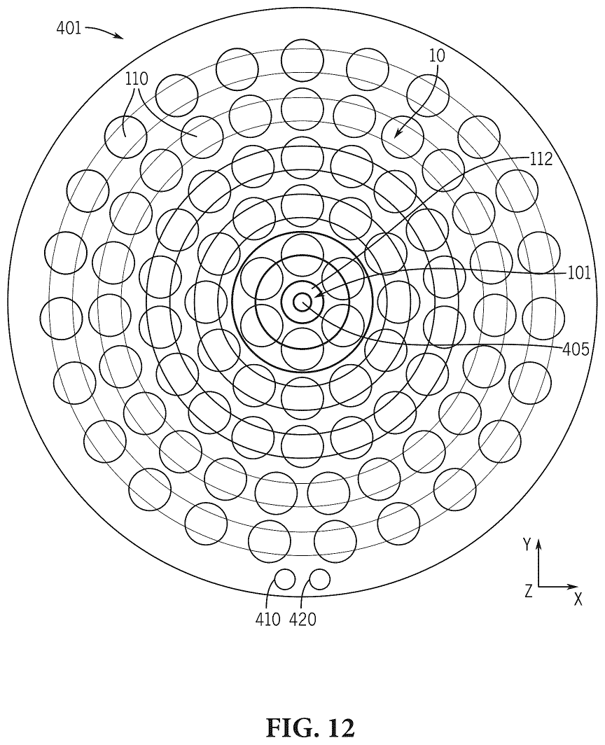

According to some examples, the streaming device 400 and/or streaming device control system 900 may include a dispenser 112. The dispenser 112 may be configured to dispense a fluid (e.g., gas, liquid). Specifically, the dispenser 112 may be configured to dispense a fluid within a streaming beam generated by the ultrasound array 10, such that the fluid is conveyed by the streaming beam to a target surface, object, or area. Referring to FIG. 12, a streaming device 401 including a dispensed 112 is illustrated in accordance with one example of the present disclosure. According to some examples, as illustrated in FIG. 12, the dispenser 112 may be disposed at and/or configured to dispense a fluid from a center 101 of the ultrasound array 10. Specifically, according to some examples, an outlet 405 of the dispenser 112 may be disposed at the center 101 of the ultrasound array 10.

Returning to FIG. 11, according to the present disclosure, the dispenser 112 may include one or more of a valve 114, a pump 115, a reservoir 116, and a water supply 117. The valve 114 and/or pump 115 may be configured to control a flow of fluid dispensed from the dispenser 112 (e.g., provided to the outlet 405 of the dispenser 112).

According to some examples, the dispenser 112 may include a reservoir 116 and/or a water supply 117. The reservoir 116 may be configured to hold or store a fluid to be dispensed by the dispenser 112. In some examples, the reservoir 116 may be configured to store a fluid under pressure (e.g., greater than 1 atm). In these examples, the dispenser 112 may include a valve 114 configured to control a flow of fluid stored in the reservoir 116 to an outlet of the dispenser 112. In other examples, the reservoir 116 may be configured to store a fluid at atmospheric pressure. In these examples, the dispenser may include a pump 115 configured to supply the fluid from the reservoir 116 to the outlet of the dispenser 112.

In some examples, the dispenser 112 may include a water supply 117. In some examples, the water supply 117 may be a residential or commercial building water supply (e.g., potable water plumbing network). The water supply 117 may be in fluid communication with the dispenser 112. In these examples, the dispenser 112 may include a valve 114 configured to selectively provide a flow of water from the water supply 117 to the outlet of the dispenser 112. In these examples, the dispenser 112 may be configured to dispense aerosolized water (e.g., water vapor, cool mist, steam). In some examples, the dispenser 112 may further include a heating element and/or a cooling element configured to control a temperature of water dispensed by the dispenser 112.

The dispenser 112 may be configured to dispense a fluid. The fluid may be a gas or aerosol. According to some examples, the dispenser 112 may include a nozzle disposed at the outlet of the dispenser 112. In some examples, the dispenser 112 may include an atomizer configured to aerosolize or separate a liquid provided to the atomizer or an outlet 405 of the dispenser 112 into a plurality of small droplets. According to some examples, a nozzle disposed at the outlet 405 of the dispenser 112 may aerosolize a liquid as it flows through the nozzle under pressure. According to other examples, the atomizer may use ultrasonic vibrations to aerosolize a liquid provided to the outlet of the dispenser 112.

The streaming device control system 900 may be configured to control the valve 114 and/or pump 115 of the dispenser 112. Specifically, the processor 910 and/or the control module 940 may be configured to send one or more control signals to the valve 114 and/or pump 115 causing the valve 114 to allow a flow of fluid to the outlet of the dispenser 112 and/or causing the pump 115 to provide a flow of fluid to the dispenser 112. The streaming device control system 900 may be configured to control a duration of time during which a fluid is dispensed and/or a volume of fluid dispensed by the dispenser 112. According to some examples, the processor 910 and/or control module 940 may be configured to send or provide on or more control signals to an atomizer causing the atomizer to aerosolize a fluid provided to an outlet 405 of the dispenser 112. According to some examples, the processor 910 and/or control module 940 may be configured to send or provide one or more control signals to a heating element and/or cooling element included in the dispenser 112 causing the heating element or cooling element to increase or decrease, respectively, the temperature of a fluid dispensed by the dispenser 112.

According to the present disclosure, the processor 910 and/or control module 940 may be configured to control the dispenser 112 in conjunction with ultrasound array 10. For example, the processor 910 and/or control module 940 may control the dispenser 112 (e.g., a valve 114, pump 115 of the dispenser 112) to dispense a fluid (e.g., gas or aerosol) while the ultrasound array 10 is generating a streaming beam. In some examples, the processor 910 and/or control module 940 may control the dispenser 112 to dispense a fluid a predetermined period of time after the ultrasound array 10 begins emitting ultrasound waves. In some examples, the processor 910 and/or control module 940 may cause the dispenser 112 to stop dispensing fluid a predetermined period of time before the ultrasound array 10 stops generating ultrasound waves, for example, such that all of the fluid dispensed is carried by a streaming beam to the target. In some examples, the predetermined period of time may correspond to a length of time required for fluid dispensed from the dispenser 112 to be conveyed by the streaming beam from the streaming device 400 to the target.

According to some examples, the processor 910 and/or control module 940 may be configured to control the dispenser 112 and ultrasound array 10 in conjunction with operation (e.g., flushing) of a plumbing fixture (e.g., toilet) proximate to the streaming device 400. Specifically, the processor 910 and/or control module 940 may control the streaming device 400 to dispense fluid and generate a streaming beam for conveying the fluid in conjunction with use or flushing of a toilet. For example, the data processing module 930 may be configured to determine based on images received from the image sensor 410 and/or proximity data received from the proximity sensor 420 that a user has entered a space proximate to a toilet and subsequently left the area proximate to the toilet and the processor 910 and/or control module 940 may be configured to control the streaming device to dispense fluid and generate a streaming beam for conveying the fluid in response to the entry and subsequent exit of a user from an a space proximate to the toilet. According to some examples, the processor 910 and/or control module 940 may control the streaming device 400 to dispense a fluid and generate a streaming beam for conveying the fluid a predetermined period of time after operation of a toilet and/or a determination (e.g., by the data processing module 930 that a user has entered and subsequently left an area proximate to the toilet.

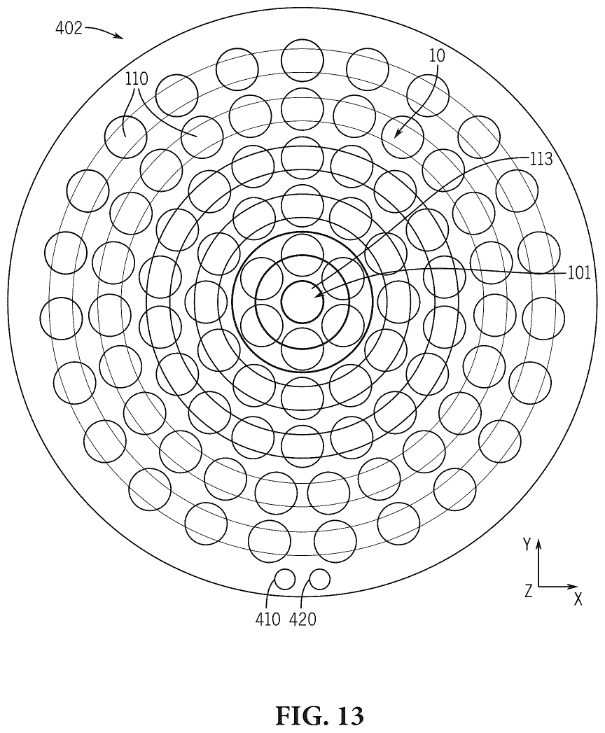

According to the present disclosure, the streaming device 400 and/or streaming device control system 900 may include a collector 113. Referring to FIG. 13, a streaming device 402 including a collector 113 is illustrated in accordance with one example of the present disclosure. According to some examples, as illustrated in FIG. 13, the collector 113 may be disposed at the center 101 of the ultrasound array 10. Specifically, according to some examples, the collector 113 may be disposed at the center 101 of the ultrasound array 10 so as to collect aerosols conveyed by a streaming beam flowing towards the ultrasound array 10 along a propagating axis extending through the center 101 of the ultrasound array 10. The collector 113 may be configured to collect or receive aerosols conveyed by a streaming beam to the collector 113. The collector 113 may include one or more surfaces disposed within a pathway of the streaming beam generated by the ultrasound array 10.

Returning to FIG. 11, according to some examples, the collector 113 may include an electrostatic precipitator 118 and/or an ultraviolet light 119. According to some examples, a streaming beam generated by the streaming device 400 may flow to and/or through the electrostatic precipitator 118. The electrostatic precipitator 118 may include a pair of electrodes coupled to a power source (either directly or through the processor 910 and/or control module 940) and configured to ionize or impart an electrostatic charge on aerosols passing through the electrostatic precipitator 118. The electrostatic precipitator 118 may further include one or more collecting surfaces or collecting plates. The collecting surfaces may have a charge (e.g., positive, negative) opposite the charge imparted on the aerosols, causing the aerosols to be attracted to and/or adhere to the collecting surfaces. The streaming device control system 900 may be configured to control the electrostatic precipitator 118. Specifically, the processor 910 and/or control module 940 may selectively provide power (e.g., electric current) and/or send or provide one or more control signals to the electrostatic precipitator 118 powering the electrodes and/or collecting surfaces, causing the electrostatic precipitator 118 to collect aerosols. In some examples, the streaming device control system 900 may control the electrostatic precipitator in conjunction with ultrasound array 10. For example, the processor 910 and/or control module 940 may control the electrostatic precipitator 118 to collect or accumulate aerosols while the ultrasound array 10 is generating a streaming beam. In some examples, the processor 910 and/or control module 940 may control the electrostatic precipitator 118 to collect or accumulate aerosols for a predetermined period of time after the ultrasound array 10 stops emitting ultrasound waves or generating a streaming beam, for example, allowing the electrostatic precipitator 118 to continue collecting aerosols as the streaming beam dissipates.

According to some examples, the collector 113 may include an ultraviolet (UV) light 119. The ultraviolet light 119 may be configured to illuminate the one or more (e.g., all of) the surfaces of the collector 113 disposed within a pathway of the streaming beam generated by the ultrasound array, disinfecting the illuminated surfaces. According to some examples, the UV light 119 may be configured to illuminate one or more surfaces of the electrostatic precipitator 118, disinfecting the illuminated surfaces. For example, the ultraviolet light 119 may be configured to illuminate the collecting surfaces or plates and/or the electrodes of the electrostatic precipitator 118.

The streaming device control system 900 may be configured to control the UV light 119. Specifically, the processor 910 and/or control module 940 may send or provide power (e.g., electric current) and/or one or more control signals to the UV light 119, causing the UV light 119 to radiate ultraviolet light and illuminate one or more surfaces of the collector 113 (including one or more surfaces of the electrostatic precipitator 118). In some examples, the processor 910 and/or control module 940 may control the UV light 119 in conjunction with the ultrasound array 10 and/or electrostatic precipitator 118. For example, the processor 910 and/or control module 940 may send one or more control signals to the UV light 119, causing the UV light 119 to illuminate one or more surfaces of the collector 113 after the ultrasound array 10 generates a streaming beam (e.g., specifically, a streaming beam flowing toward the ultrasound array 10) and/or after the electrostatic precipitator 119 has collected aerosols. In some examples, the processor 910 and/or control module 940 may send one or more control signals to the UV light 119 causing the UV light 119 to illuminate one or more surfaces of the collector 113 for a predetermined period of time at a predetermined interval (e.g., after a predetermined interval of time has passed). For example, the processor 910 and/or control module 940 may send one or more control signals to the UV light 119 causing the UV light to illuminate one or more surfaces of the collector 113 for in the range of 3-60 seconds every hour, every 3 hours, every 6 hours, every 12 hours or the like.

According to some examples, the processor 910 and/or control module 940 may be configured to control the collector 113 and/or ultrasound array 10 in conjunction with operation (e.g., flushing) of a plumbing fixture (e.g., toilet) proximate to the streaming device 400. Specifically, the processor 910 and/or control module 940 may control the streaming device 400 to generate a streaming beam (e.g., flowing toward the streaming device) for conveying aerosols to a collector 113 in conjunction with use or flushing of a toilet. For example, the data processing module 930 may be configured to determine based on images received from the image sensor 410 and/or proximity data received from the proximity sensor 420 that a user has entered a space proximate to a toilet and subsequently left the area proximate to the toilet and the processor 910 and/or control module 940 may be configured to control the streaming device to generate a streaming beam for conveying aerosols from an area proximate to the toilet in response to the entry and subsequent exit of a user from an a space proximate to the toilet. In other examples, the streaming device control system 900 may be in communication with the toilet or another fixture (e.g., in a bathroom) and receive information on operation of the fixture from the fixture. According to some examples, the processor 910 and/or control module 940 may control the streaming device 400 to generate a streaming beam for conveying aerosols to a collector 113 beginning at a time of operation of a toilet and/or a determination (e.g., by the data processing module 930 that a user has entered and subsequently left an area proximate to the toilet or a predetermined period of time after operation of a toilet and/or a determination (e.g., by the data processing module 930 that a user has entered and subsequently left an area proximate to the toilet. In some examples, the processor 910 and/or control module 940 may be configured to operate or turn on an electrostatic precipitator 118 of the collector 113 for the period of time during which a streaming beam is generated.

According to some examples of the present disclosure, the streaming device 400 may include one or more of a center transducer 111, a dispenser 112, and a collector 113 at the center 101 of the ultrasound array 100. For example, the streaming device 400 may include a center transducer 111 and a dispenser 112. In other examples, the streaming device 400 may include a center transducer 111 and a collector 113. In yet other examples, the streaming device 400 may include a dispenser 112 and a collector 113. In still other examples, the streaming device 400 may include all three of a center transducer 111, a dispensed 112, and a collector 113.

According to some examples, the streaming device 400 and/or streaming device control system 900 may include an image sensor 410 and/or a proximity sensor 420. According to some examples, the image sensor 410 and/or proximity sensor 420 may be included in the streaming device 400. According to some examples, as illustrated in FIGS. 12 and 13, the image sensor 410 and/or proximity sensor 420 may be disposed on a front surface of a streaming device 401, 402. The image sensor 410 and proximity sensor 420 may be in communication with streaming device control system 900. Specifically, the image sensor 410 and proximity sensor 420 may be in communication with the processor 910 and/or memory 920. Additionally, the image sensor 410 and proximity sensor 420 may be in communication with the data processing module 930 and/or the control module 940. The streaming device control system 900 may be in communication with the image sensor 410 and/or the proximity sensor 420 so as to receive image data and/or proximity data generated by the image sensor 410 and the proximity sensor 420, respectively.

The data processing module 930 may include an image processing module 931 and an object classifier 932. The image processing module 931 may be configured to process images or other data received from the image sensor 410. The image processing module 931 may be configured to identify objects included in images. The object classifier 932 may be configured to classify the objects in the images. The streaming device control system 900 may be configured to generate control signals for the ultrasound array 10 based on the classification of objects included in the images. Specifically, the streaming device control system 900 may generate control and/or ultrasound signals for the ultrasound transducers 110 included in the ultrasound array 10 to control an orientation of a propagating axis along which a streaming beam is generated by the ultrasound array 10, such that the steaming beam conveys a fluid to a target corresponding to a classified object included in the image. In some examples, the streaming device control system 900 may generate control and/or ultrasound signals individually for each of the ultrasound transducers 110 included in the ultrasound array 10, such that a fluid (e.g., dispensed by a dispenser 112) is conveyed to a target surface or object identified and classified by the data processing module 930.

According to some examples, the streaming device control system 900 may generate control and/or ultrasound signals for the ultrasound transducers 110 such that a streaming beam is generated along a propagating axis extending between the ultrasound array 10 a target surface or object including a surface or surfaces of a toilet, a toilet seat, a toilet actuator (e.g., flush lever or handle), a urinal, a urinal actuator, a shower or bath (e.g., floors, walls), a faucet, a faucet handle, a counter top, a dispenser (e.g., paper towel dispenser, other dispenser), a door handle (e.g., stall handle) classified by the object classifier 932 such that a fluid may be conveyed by the streaming beam the target surface or object.

According to some examples, the streaming device control system 900 may generate control and/or ultrasound signals for the ultrasound transducers 110 such that a streaming beam is generated along a propagating axis extending between the ultrasound array 10 target anatomy, for example, a face, neck, or wrists of a user classified by the object classifier 932 such that a fluid may be conveyed by the streaming beam to the target anatomy. According to some examples, the streaming device control system 900 may be configured to change an orientation of a streaming beam generated by the ultrasound array 10 repeatedly or continuously (e.g., as a user moves) such that a fluid is continuously conveyed to the specific anatomy of the user.

The processor 910 and memory 920 may form a processing circuit. The processor 910 may be configured to execute instructions stored in the memory 920 or may execute instructions otherwise accessible to the processor 910. In some examples, the one or more processors 910 may be embodied in various ways. The processor 910 may be constructed in a manner sufficient to perform at least the operations described herein. In some examples, the processor 910 may be shared by multiple circuits (e.g., circuit A and circuit B may comprise or share the same processor which, in some examples, may execute instructions stored, or otherwise accessed, via different areas of memory 920). Alternatively, or additionally, the processor 910 may be structure to perform or otherwise execute certain operations independent of one or more co-processors. In other examples, two or more processors 910 may be coupled via a bus to enable independent, parallel, pipelined, or multi-threaded instruction execution. Each processor 910 may be implemented as one or more general-purpose processors, application specific integrated circuits (ASICs), field programmable gate arrays (FPGAs), digital signal processors (DSPs), or other suitable electronic data processing components structure to execute instructions provided by memory. The processor 910 may take the form of a single core processor, multi-core processor (e.g., a dual core processor, triple core processor, quad core processor, etc.), microprocessor, etc.

The memory 920 may include non-transient volatile storage media, non-volatile storage media, non-transitory storage media (e.g., one or more volatile and/or non-volatile memories), etc. In some examples, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other examples, the volatile storage media may take the form of RAM, TRAM, ZRAM, etc. Combinations of the above are also included within the scope of machine-readable media. The memory 920 may store machine-readable executable instructions which are executed by the processor 910. In this regard, machine-executable instructions comprise, for example, instructions and data which cause a general purpose computer, special purpose computer, or special purpose processing machines to perform a certain function or group of functions. The memory 920 may be operable to maintain or otherwise store information relating to the operations performed by one or more associated circuits, including processor instructions and related data (e.g., database components, object code components, script components, etc.), in accordance with the examples described herein.

In some examples, at least some of the components of the of streaming device control system 900 may execute locally. For instance, the processor 910 and memory 920 may be implemented, incorporated, or otherwise execute on a local computing device which is located at or near the streaming device 400. For example, the local computing device may be mounted at or near the streaming device 400. In some examples, the local computing device may be disposed in wall (e.g., to which the streaming device is coupled) proximate to the streaming device 400. The streaming device control system 900 is communicably coupled to the image sensor 410 and/or proximity sensor 420. The streaming device control system 900 may be configured to execute locally to process data received from the image sensor 410 and/or proximity sensor 420 and control the ultrasound array 10 based on, at least, the data from the image sensor 410 and/or range sensor 420.

The image sensor 410 may include a camera. The camera may include a lens and an image capture element. The image capture element can be any suitable type of imaging capture device or system, including, for example, an area array sensor, a Charge Coupled Device (CCD) sensor, a Complementary Metal Oxide Semiconductor (CMOS) sensor, or a linear array sensor, and the like. The image capture element may capture images in any suitable wavelength on the electromagnetic spectrum. The image capture element may capture color images and/or greyscale images. In other examples, the image sensor 410 may include other types of sensors configured to generate image data. For instance, the image sensor 410 may include an infrared sensor, a plurality of range sensors, and the like.

The proximity sensor 420 may include a signal transmitter, a signal detector, and a timer. The proximity sensor 420 may be configured to transmit a signal into or toward a medium, for example, via the signal transmitter. The proximity sensor 420 may be configured to detect the signal reflected off of the medium, for example, using the signal detector. The proximity sensor 420 may be configured to calculate a distance or range between the signal transmitter and the medium based on a duration between the time in which the signal is transmitted and the reflected signal is detected. For example, the proximity sensor 420 may be an ultrasonic sensor, a radar sensor, a light detection and ranging (LIDAR) sensor, a sonar sensor, and the like.

The streaming device control system includes a data processing module 540. The data processing module 540 is configured to process, interpret, or otherwise analyze data received from the image sensor 410 and/or proximity sensor 420. The data processing module 540 may include the image processing module 931 and the object classifier 932.

The image processing module 931 and the object classifier 932 may be or include any software, instructions, or other digital commands which are configured to process images received from the image sensor 410. In some examples, the image processing module 931 and/or object classifier 932 may be or include a neural network. The neural network may be a series of input layers, hidden layers, and output layer(s) which are configured to receive an input (e.g., an image), process the image to detect various characteristics within the image (e.g., at the hidden layer), and provide an output. The neural network may be trained prior to deployment. Hence, the neural network may be static at deployment (e.g., when processing images from the imaging sensor 410 in real-time).

The image processing module 931 may be or include software and/or hardware generally configured to identify objects within an image received from the image sensor 410. The image sensor 410 may be mounted such that the image sensor's field of view includes a user proximate to the streaming device 400. According to some examples, as illustrated in FIGS. 12 and 13, the image sensor 410 may be disposed on a front of a streaming device 401, 402. In some examples, the streaming device 400 may be disposed proximate to a mirror and/or sink (e.g., within a bathroom or lavatory) such that the image sensor's field of view includes a user standing at the mirror and/or sink. In another example, the streaming device 400 may be disposed within a shower, such that the image sensor's field of view includes a user standing in the shower. A position of the streaming device 400 and/or image sensor 410 may be fixed such that the image sensor's field of view includes a portion of a room (e.g., bathroom, bedroom) or a space (e.g., shower) in which the image sensor 410 is mounted. Accordingly, each of the images or the image data received from the image sensor 410 may have fixed portions corresponding to a portion of the room or space in which the image sensor 410 is disposed. Hence, the images typically have a fixed (or set) background. The image processing module 931 may be configured to identify objects within images based on the difference between the background (e.g., a portion of the room or space in which the image sensor 410 is disposed) and the images or image data received from the image sensor 410. The image processing module 931 may be configured to compare the images or image data received from the image sensor 410 to a static image of the room or space, for example, when a user is not present in the foreground of the image or the image data of the room or space. The static image of the room or space in which the image sensor 410 is disposed may be stored locally (e.g., within memory 920). The image processing module 931 may be configured to identify objects within the images based on the comparison (e.g., when there is a difference between the static image of the background and the images received from the image sensor 410).

The object classifier 932 may be or include software and/or hardware configured to assign a classification to objects in the images or the image data. The object classifier 932 may be configured to assign the classification by, for instance, identifying various features within the portion of the image corresponding to the object, based on object matching, object edge detection and matching, model matching, interpretation trees, and the like. The object classifier 932 may include, incorporate, or otherwise use algorithms corresponding to the above-mentioned methods for classifying objects.

Specifically, the object classifier 932 may be configured to classify various fixtures in an environment (e.g., a bathroom environment), for example, a toilet, urinal, sink, shower, or another fixture in a bathroom environment and/or anatomy (e.g., body parts) of a user standing in front of the image sensor 410. For example, the object classifier 932 may be configured to assign a classification to one or more of a head, a face, a neck, a torso, arms, armpits, a wrist, or the like of a user standing in front of the image sensor 410. The processor 910 and/or control module 940 may be configured to identify a fixture or a body part classified by the object classifier 932 as corresponding to a target object to which a fluid is to be conveyed by a streaming beam. Specifically, the processor 910 and/or control module 940 may be configured to cross-reference a classification assigned to an object in an image or image data from the image sensor 410 to determine if the classification assigned to the object corresponds to a target object.

The data processing module 930 may be configured to determine the position of an object classified by the object classifier 932. Specifically, the data processing module 930 may be configured to determine position information or position information indicative of a position of an object classified by the object classifier 932 relative to the image sensor 410 and/or proximity sensor 420 using data collected by the image sensor 410 (e.g., image data) and/or the proximity sensor 420 (e.g., range data). The data processing module 930 may be further configured to determine position information or position data indicative of a position of the object classified by the object classifier 932 relative to the ultrasound array (e.g., a center 101 of the ultrasound array 10) using a known or measured distances between the center 101 of the ultrasound array 10 and the image sensor 410 and/or a known or measured distance between the center 101 of the ultrasound array 10 and the proximity sensor 420.

The processor 910 and/or control module 940 may be configured to generate control signals and/or ultrasound signals for the ultrasound array 10. In some examples, the processor 910 and/or control module 940 may be configured to generate and/or send or provide control signals and/or ultrasound signals to the ultrasound transducers 110 included in the ultrasound array 10 on an individual basis. Specifically, the processor 910 and/or control module 940 may individually generate a control and/or ultrasound signals for each ultrasound transducer 110 and/or send or provide different control and/or ultrasound signals to each of the ultrasound transducers 110.

In other examples, the processor 910 and/or control module 940 may be configured to generate and/or send or provide control and/or ultrasound signals to the ultrasound transducers on a collective basis. Specifically, the processor 910 and/or control module 940 may generate a control and/or ultrasound signal for a group of two or more ultrasound transducers 110 and provide the same control and/or ultrasound signal to two or more ultrasound transducers 110 included in the ultrasound array 10. In some examples, the processor 910 and/or control module 940 may generate and provide different control and/or ultrasound signals to two or more groups of ultrasound transducers 110. For example, with respect to the ultrasound array 100, the processor 910 and/or control module 940 may generate and provide different control and/or ultrasound signals to the ultrasound transducers 110 included in each ring (e.g., 141, 142, 143, 144, 145) of ultrasound array 100.

In another example, the processor 910 and/or control module 940 may generate and provide the same control and/or ultrasound signals to all of the ultrasound transducers 110 included in the ultrasound array 10. For example, with respect to the ultrasound array 200, the processor 910 and/or control module 940 may generate and provide the same control and/or ultrasound signals to all of the ultrasound transducers 110 included in the ultrasound array 10.

According to some examples, a streaming device 400 according to the present disclosure may be configured to generate a streaming beam along a single, fixed or stationary propagating axis (e.g., 120, 121). Specifically, in these examples, the ultrasound array 10 and/or streaming device control system 900 may be configured to generate a streaming beam along a single, fixed propagating axis (e.g., 120, 121). For example, referring to the ultrasound array 200, the ultrasound transducers 110 may be offset from a primary plane 102 a distance proportional to a distance along the primary plane 102 between the center 101 of the ultrasound array 200 and a respective ultrasound transducer 110, such that a streaming beam is generated when the same control and/or ultrasound signals are provided to all of the ultrasound transducers 110 included in the ultrasound array 200. In another example, the ultrasound array 100 may be configured to include all of the ultrasound transducers 110 in a respective ring on the same channel, such that a streaming beam is generated when the same control and/or ultrasound signals are provided to all of the ultrasound transducers 110 included in a respective ring 140 of the ultrasound array 200.

According to some examples of the present disclosure, a streaming device 400 configured to generate a streaming beam along a single, fixed or stationary propagating axis may advantageously have a less complex structure and require less computing power than a streaming device 400 described herein configured to generate streaming beams about multiple propagating axes. Accordingly, a streaming device 400 configured to generate a streaming beam along a single, fixed or stationary propagating axis may advantageously be less expensive and easier to manufacture than a streaming device 400 configured to generate streaming beams about multiple propagating axes.

According to other examples, a streaming device 400 according to the present disclosure may be configured to dynamically generate a streaming beam about multiple propagating axes having different orientations. Specifically, in these examples, the ultrasound transducers 110 included in the ultrasound array 10 may each be provided on their own channel, so as to individually receive control and/or ultrasound signals from the processor 910 and/or control module 940. Further, in these examples, the processor 910 and/or control module 940 may be configured to independently generate and provide control and/or ultrasound signals to each ultrasound transducer 110 included in the ultrasound array 10.

According to some examples, changing the orientation of a propagating axis along which a streaming beam is generated may advantageously increase the area of a surface to which the streaming beam is able to convey a fluid. For example, a streaming beam may convey fluid to a different portion of a surface or object as an orientation of the propagating axis along which the fluid is conveyed and thus a point at which the streaming beam contacts the surface or object changes. According to some examples, the streaming device control system 900 may control the orientation of the propagating axis over time such that during a cleaning event or cycle the streaming beam impinges on and thus a fluid (e.g., cleaning fluid) is provided to an entirety of a selected or predetermined target surface, object, or pathway.

According to other examples, changing the orientation of a propagating axis along which a streaming beam is generated may advantageously allow a streaming device 400 to generate a streaming beam toward and thus convey a fluid toward a target that moves over time or to multiple targets (e.g., disposed at different locations). Specifically, according to some examples of the present disclosure, the ability to change an orientation of a propagating axis along which a streaming beam is generated may allow the streaming device 400 to generate an streaming beam toward and/or convey fluid to an object classified by the object classifier 932 and identified by the control module 940 as corresponding to a target (e.g., to which a fluid may be conveyed and/or from which aerosols may be collected).

According to the present disclosure, the streaming device control system 900 may be configured to change a propagating axis along which a streaming beam is generated by changing an axis around which collective wavefronts emitted by all of the ultrasound transducers 110 included in the ultrasound array 10 are symmetrical. Specifically, the streaming device control system 900 may change an axis around which collective wavefronts emitted by all of the ultrasound transducers 110 included in the ultrasound array 10 are symmetrical by changing or shifting the phase of an ultrasound wave emitted from one or more (e.g., each) of the ultrasound transducers 110. The streaming device control system 900 may control the phase of an ultrasound wave emitted from each ultrasound transducer 110 using one or more control and/or ultrasound signals generated by the streaming device control system 900 and provided to a respective ultrasound transducer 110.

In accordance with some examples of the present disclosure, the control module 940 may be configured to determine the phase of an ultrasound wave to be emitted and/or the magnitude of a phase shift (e.g., relative another ultrasound transducer (e.g., center transducer 111) of ultrasound wave emitted from each ultrasound transducer 110 based on a position of the respective ultrasound transducer 110 (e.g., relative to a center 101 of the ultrasound array 10) and an orientation of a propagating axis selected by a user and/or the streaming device control system 900 along which a streaming beam may be generated. Specifically, the control module 940 may be configured to determine the phase of an ultrasound wave to be emitted and/or the magnitude of a phase shift (e.g., relative another ultrasound transducer (e.g., center transducer 111) of an ultrasound wave emitted from each ultrasound transducer 110 such that collective wavefronts emitted by all of the ultrasound transducers 110 included in the ultrasound array are symmetrical are the selected propagating axis.

According to some examples of the present disclosure, the memory 920 may be configured to store a position of each ultrasound transducer 110 included in the ultrasound array 10. For example, the memory may store a position of each ultrasound transducer 110 relative to a center 101 of the ultrasound array 10. Additionally, the memory 920 may be configured to store one or more algorithms for determining the phase of an ultrasound wave to be emitted and/or the magnitude of a phase shift of an ultrasound wave emitted from each ultrasound transducer 110 based on a position of the respective ultrasound transducer 110 and a selected propagating axis such that collective wavefronts emitted by all of the ultrasound transducers 110 included in the ultrasound array 10 are symmetrical around the selected propagating axis.

The processor 910 and/or control module 940 may be configured to determine the orientation of a propagating axis extending between the ultrasound array 10 and a target. Specifically, in some examples, the processor 910 and/or control module 940 may be configured to determine the orientation of a propagating axis extending between the ultrasound array 10 and an object classified by the object classifier 932 and identified as corresponding to a target. Specifically, the processor 910 and/or control module 940 may be configured to determine the orientation of a propagating axis extending between the ultrasound array 10 and the object identified as a target, such that a streaming beam for conveying a fluid to the target and/or conveying aerosols away from the target may be generated along the propagating axis. Specifically, the processor 910 and/or control module 940 may be configured to determine the orientation of a propagating axis extending between the ultrasound array 10 and the target object (e.g., classified object identified as corresponding to the target) using the position information or position data as determined by the processor 910 and/or control module 940. In some examples, the propagating axis may extend between the center of the ultrasound array 10 and the target. In other examples, the propagating axis may extend from a point other than the center of the ultrasound array 10 and the target.

According to some examples, the processor 910 and/or control module 940 may be configured to repeatedly or continuously determine position information or position data indicative of a position of the target object relative to the image sensor 410, proximity sensor 420, and/or (e.g., center 101 of) the ultrasound array 10. Accordingly, the processor 910 and/or control module 940 may be configured to track a position of the target object as the target object moves over time.

Similarly, in some examples, the processor 910 and/or control module 940 may be configured to repeatedly or continuously determine the orientation of a propagating axis (e.g., 120, 121) extending between the ultrasound array 10 and the target object. Accordingly, the processor 910 and/or control module 940 may be configured to update the orientation of propagating axis extending between the ultrasound array 10 and the target object as the target object moves over time.

In some examples, the processor 910 and/or control module 940 may be configured to repeatedly or continuously change the orientation of a propagating axis along which a streaming beam is generated based on or using the determined orientation of the propagating axis extending between the ultrasound array 10 and the target object. Accordingly, the processor 910 and/or control module 940 may be configured to change the orientation of a propagating axis along which a streaming beam is generated as the target object moves over time.

In some examples, the processor 910 and/or control module 940 may send one or more control signals to the ultrasound array 10, collector 112, and/or dispenser 113, causing the streaming device to generate a streaming beam (e.g., and dispense fluid and/or turn on the electrostatic precipitator 118 and/or UV light) for a predetermined period of time at a predetermined interval (e.g., after a predetermined interval of time has passed). Accordingly, the streaming device 400 may dispense and convey a fluid and or collect aerosols at scheduled intervals (e.g., every 3 hours, every 6 hours, every 12 hours or the like).

According to some examples, the streaming device 400 and/or streaming device control system may include a power supply 430 connected to the streaming device control system 900 (e.g., processor 910, memory 920), the ultrasound array 10, the dispenser 112, the collector 113, the image sensor 410, and/or the proximity sensor 420. The power supply 430 may be configured to supply power to one or more of the streaming device control system 900 (e.g., processor 910, memory 920), the ultrasound array 10, the dispenser 112, the collector 113, the image sensor 410, and/or the proximity sensor 420. In some examples, the power supply 430 may include a plug and/or wall outlet. For example, the power supply may include a building power supply (e.g., a wall outlet). In other examples, the power supply 430 may include one or more (e.g., rechargeable) batteries.

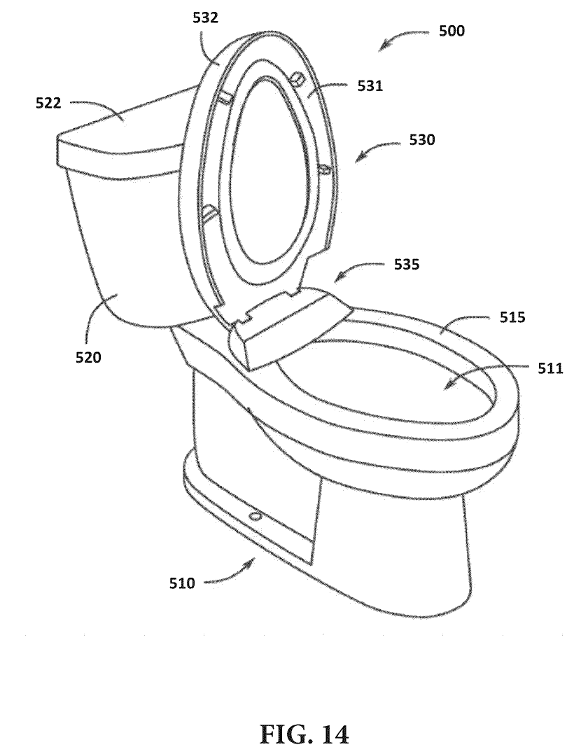

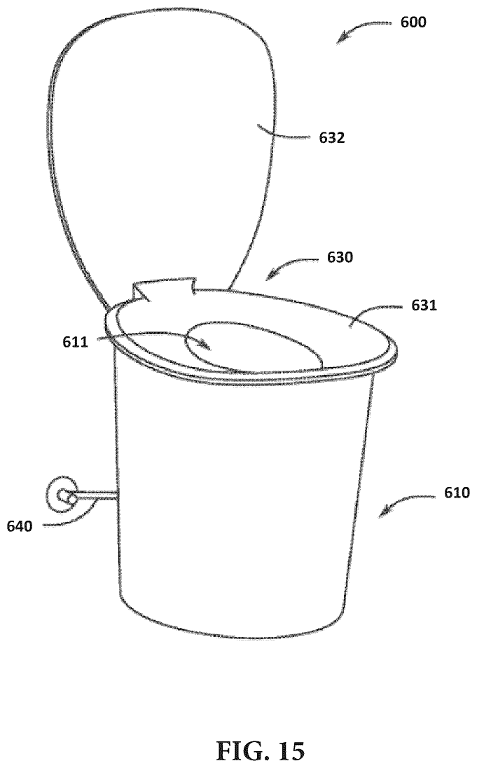

Referring generally to FIGS. 14 and 15, toilets are illustrated in accordance with two examples of the present disclosure. According to the present disclosure, the acoustic streaming devices described herein may be configured to dispense and convey a cleaning solution to one or more surfaces of the toilets 500, 600 and/or convey aerosols away from the toilets 500, 600.

Referring to FIG. 14 a toilet 500 including a base 510 (e.g., a pedestal, bowl, etc.) and a tank 520 is shown. The base 510 is configured to be attached to another object such as a drainpipe, floor, or another suitable object. The base 510 includes a bowl 511, a sump (e.g., a receptacle) disposed below the bowl 511, and a trapway fluidly connecting the bowl 511 to a drainpipe or sewage line. The tank 520 may be supported by the base 510, such as an upper surface of a rim 515. The tank 520 may be integrally formed with the base 510 as a single unitary body. In other embodiments, the tank 520 may be formed separately from the base 510 and coupled (e.g., attached, secured, fastened, connected, etc.) to the base 510. The toilet 500 may further include a tank lid 522 covering an opening and inner cavity in the tank 520. The toilet 500 may include a seat assembly 530 including a seat 531 and a seat cover 532 rotatably coupled to the base 510. The toilet 500 may further include a hinge assembly 535.

Referring to FIG. 13, a tankless toilet 600 is shown. The toilet 600 includes a base 610 and a seat assembly 630 coupled to the base. The base 610 includes a bowl 611, a sump disposed below the bowl 611, and a trapway fluidly connecting the bowl 611 to a drainpipe or sewage line. The toilet 600 includes a waterline 640 that supplies the toilet 600 with water. The toilet 600 may further include a seat assembly 630 including a seat 631 and a seat cover 632 rotatably coupled to the base 610. The toilets 500 and 600 of FIGS. 14 and 15 are provided herein as non-limiting examples of toilets that may be configured to utilize aspects of the present disclosure.

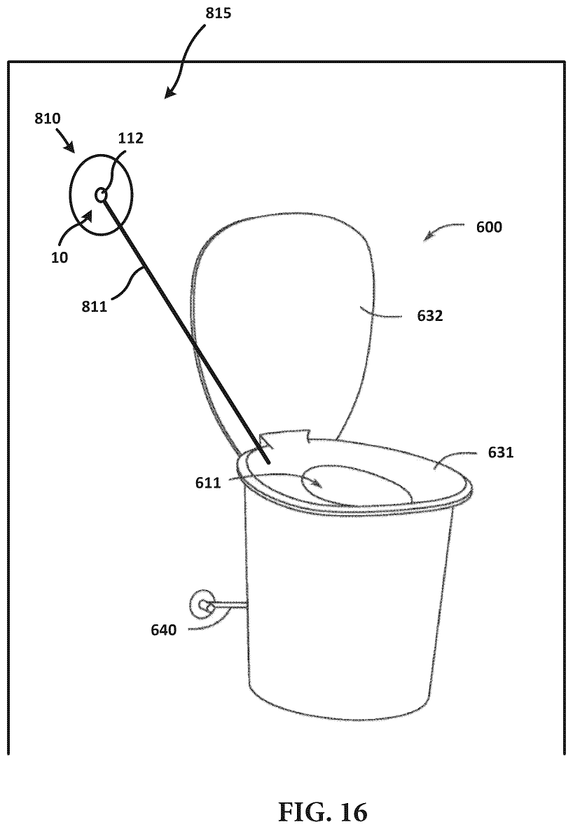

Referring to FIG. 16, a streaming device 810 is illustrated in accordance with one example of the present disclosure. The streaming device 810 may be the same or substantially similar to the streaming devices 400, 401 described above with respect to FIGS. 9 and 12. According to some examples, as illustrated in FIG. 16, the streaming device 810 may be disposed proximate to a toilet 600. Although illustrated and described in connection with the toilet 600, the present disclosure is not limited thereto and the streaming device 810 may instead be disposed proximate to the toilet 500 and perform the same operations, functions, or the like with respect to the toilet 500.

According to some examples, the streaming device 810 may be disposed on a wall 815 (e.g., of a bathroom) proximate to the toilet 600. For example, the streaming device 810 may disposed on a wall 815 behind the toilet 600. According to some examples, the streaming device 810 may be disposed on a wall 815 behind the toilet 600 and offset from the toilet 600 such that a streaming beam may extend from the streaming device 810 to any point on a (e.g., top) surface of a rim or seat 631 of the toilet 600 without being blocked, for example, by a tank (e.g., 520) of the toilet and/or a toilet seat cover 632 disposed in a vertical orientation.

As illustrated in FIG. 16, the streaming device 810 may include a dispenser 112 and be configured to generate a streaming beam 811 extending between the streaming device 810 and the toilet 600. According to some examples, as illustrated in FIG. 16, the streaming device 810 may be configured to dispense a fluid (e.g., a cleaning fluid) and convey the fluid to the toilet using the streaming beam 811. Specifically, the dispenser 112 may be configured to dispense a cleaning fluid and a streaming beam 811 generated by the ultrasound array 10 may be configured to convey a cleaning fluid to a target surface or surfaces of the toilet 600.

For example, the streaming device 810 may be configured to dispense and convey a cleaning fluid to a target surface(s) including surface(s) of a toilet seat 631, surface(s) of a rim (e.g., 515), surface(s) of a base 610, surface(s) of a seat cover 632, surface(s) of a tank (e.g., 520), surface(s) of a tank lid 522, surfaces of an a actuator (e.g., flush lever or handle), and the like.

According to some examples, the streaming device 810 may be configured to generate a streaming beam 811 that moves over time such that a dispensed cleaning fluid may be conveyed to multiple surfaces and/or a portion of a surface or surfaces larger than a cross sectional area of the streaming beam 811.

According to some examples of the present disclosure, the cleaning fluid may be configured to disinfect the surface(s) to which it is conveyed or applied. The cleaning fluid may be nay liquid chemical, chemical compound, chemical element of combination thereof. For examples, the cleaning solution may include for example, hydrogen peroxide (H₂O₂), sodium hypochlorite (NaOCl), peroxyacetic acid, ozonated water, electrolyzed water, hypochlorous acid, or the like.

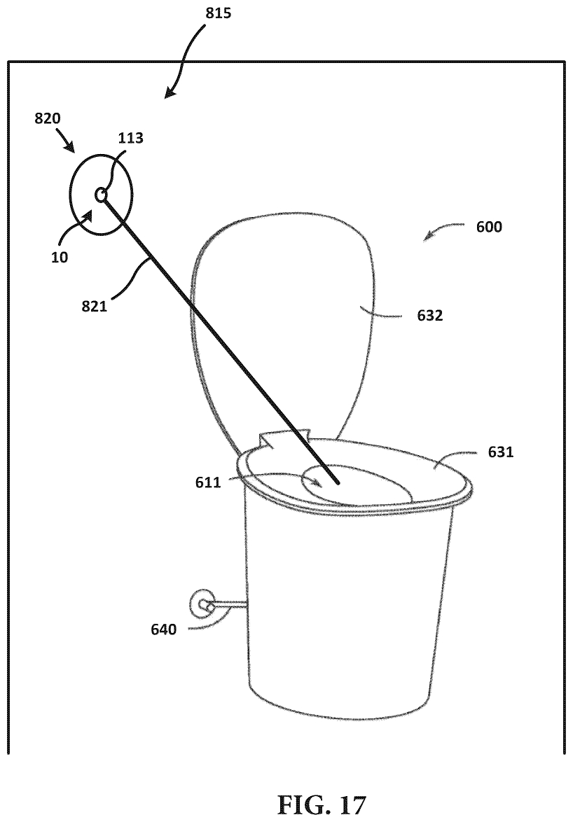

Referring to FIG. 17, a streaming device 820 is illustrated in accordance with one example of the present disclosure. The streaming device 820 may be the same or substantially similar to the streaming devices 400, 402 described above with respect to FIGS. 9 and 13. According to some examples, as illustrated in FIG. 17, the streaming device 820 may be disposed proximate to a toilet 600. Although illustrated and described in connection with the toilet 600, the present disclosure is not limited thereto and the streaming device 810 may instead be disposed proximate to the toilet 500 and perform the same operations, functions, or the like with respect to the toilet 500.

According to some examples, the streaming device 820 may be disposed on a wall 815 (e.g., of a bathroom) proximate to the toilet 600. For example, the streaming device 810 may disposed on a wall 815 behind the toilet 600. According to some examples, the streaming device 810 may be disposed on a wall 815 behind the toilet 600 and offset from the toilet 600 such that a streaming beam may extend from the streaming device 820 to a bowl 611 of the toilet 600 without being blocked, for example, by a tank (e.g., 520) of the toilet and/or a toilet seat cover 632 disposed in a vertical orientation.

As illustrated in FIG. 17, the streaming device 820 may include a collector 113 and be configured to generate a streaming beam 821 extending between the streaming device 820 and the toilet 600 or an area proximate to the toilet 600. According to some examples, as illustrated in FIG. 16, the streaming device 820 may be configured to generate a streaming beam 821 flowing toward the streaming device 820, such that the streaming beam may convey aerosols from an area proximate to the toilet 600 or from the toilet 600 to the collector 113 included in the streaming device 800. Specifically, the streaming device 820 may generate a streaming beam 821 configured to collect and/or convey aerosols from an area or space proximate to a toilet 600 to a collector 113 included in the streaming device 820.

As noted above, according to some examples, the streaming device 820 may be configured to generate the streaming beam 821 in conjunction with operation (e.g., flushing of the toilet 600. Specifically, as described above in detail, the streaming device 820 may begin generating the streaming beam 821 for collecting aerosols from a space or area proximate to the toilet 600 at the time of operation of the toilet 600 and/or a determination (e.g., by the data processing module 930 that a user has entered and subsequently left an area proximate to the toilet 600. According to another example, the streaming device 820 may begin generating the streaming beam 821 for collecting aerosols from a space or area proximate to the toilet 600 at a predetermined period of time after operation of a toilet and/or a determination (e.g., by the data processing module 930 that a user has entered and subsequently left an area proximate to the toilet. According to some examples of the present disclosure, the streaming device 820 may be operated in conjunction with flushing of the toilet 600 so as to collect aerosols or plume emitted from the toilet during flushing of the toilet 600.

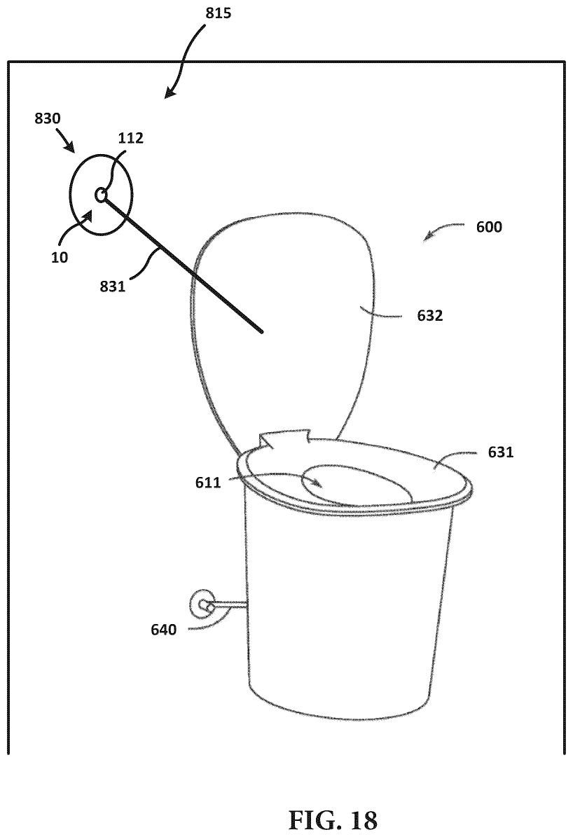

Referring to FIG. 18, a streaming device 830 is illustrated in accordance with one example of the present disclosure. The streaming device 830 may be the same or substantially similar to the streaming devices 400, 401 described above with respect to FIGS. 9 and 12. According to some examples, as illustrated in FIG. 18, the streaming device 830 may be disposed proximate to a toilet 600. Although illustrated and described in connection with the toilet 600, the present disclosure is not limited thereto and the streaming device 830 may instead be disposed proximate to the toilet 500 and perform the same operations, functions, or the like with respect to the toilet 500.

According to some examples, the streaming device 830 may be disposed on a wall 815 (e.g., of a bathroom) proximate to the toilet 600. For example, the streaming device 830 may disposed on a wall 815 behind the toilet 600. According to some examples, the streaming device 830 may be disposed on a wall 815 behind the toilet 600 and offset from the toilet 600 such that a streaming beam may extend from the streaming device 830 to the bowl 611 and/or an area or space above the bowl 611 of the toilet 600 without being blocked, for example, by a tank (e.g., 520) of the toilet and/or a toilet seat cover 632 disposed in a vertical orientation.

As illustrated in FIG. 18, the streaming device 830 may include a dispenser 112 and be configured to generate a streaming beam 831 extending between the streaming device 810 and the toilet 600. According to some examples, as illustrated in FIG. 16, the streaming device 810 may be configured to dispense a deodorant or air freshener and convey the deodorant or air freshener to a space or area proximate to the toilet using the streaming beam 831. For example, the dispenser 112 may be configured to dispense a deodorant or aerosol and a streaming beam 831 generated by the ultrasound array 10 may be configured to convey the deodorant or air freshener to the toilet and/or an area or space proximate to the toilet 600 (e.g., a space or area above the bowl 611 of the toilet 600).

As noted above, according to some examples, the streaming device 830 may be configured to dispense a deodorant or air freshener and generate the streaming beam 831 in conjunction with operation (e.g., flushing of the toilet 600). Specifically, as described above in detail, the streaming device 820 may be configured to dispense a deodorant or air freshener and begin generating the streaming beam 831 for conveying the deodorant or air freshener to the toilet 600 and/or an area proximate to the toilet 600 at a predetermined period of time after operation of the toilet 600 and/or a determination (e.g., by the data processing module 930 that a user has entered and subsequently left an area proximate to the toilet 600. According to some examples of the present disclosure, the streaming device 830 may be operated in conjunction with flushing of the toilet 600 so as to deodorize or freshen air proximate to the toilet after flushing of the toilet 600.

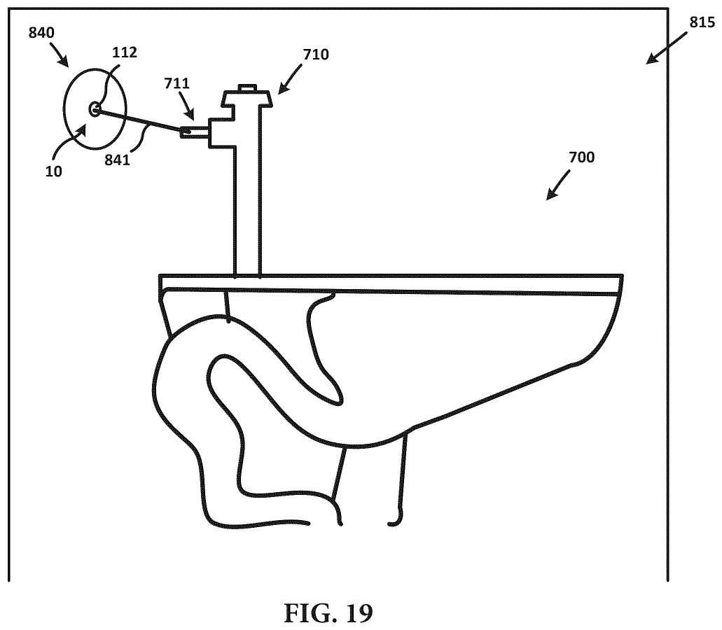

Referring to FIG. 19, a streaming device 840 is illustrated in accordance with one example of the present disclosure. The streaming device 840 may be the same or substantially similar to the streaming devices 400, 401 described above with respect to FIGS. 9 and 12. According to some examples, as illustrated in FIG. 19, the streaming device 840 may be disposed proximate to a toilet 700. The toilet 700 may be the same or substantially similar to the toilets 500 and/or 600 described above with respect to FIGS. 14 and 15.

According to some examples, the toilet 700 may be disposed in a commercial or public setting and may include a flush actuator 710. According to some examples, the toilet 700 may be an in-line toilet configured to receive water under pressure (e.g., from the plumbing network of a commercial building). The flush actuator 710 may include a handle 711 and may be configured to initiate or begin an operational (e.g., flushing) cycle of the toilet 700 when the handle 711 is operated by a user. According to some examples, the flush actuator 710 may include a pilot valve for initiating and/or controlling an operational cycle of the toilet 700.

According to some examples, the streaming device 840 may be disposed on a wall 815 (e.g., of a bathroom) proximate to the toilet 700. For example, the streaming device 840 may disposed on a wall 815 behind the toilet 700. According to some examples, the streaming device 840 may be disposed on a wall 815 behind the toilet 700 and offset from the toilet 700.

As illustrated in FIG. 19, the streaming device 840 may include a dispenser 112 and be configured to generate a streaming beam 841 extending between the streaming device 840 and the toilet 700. Specifically, the streaming device 840 may be configured to generate a streaming beam 841 extending between the streaming device 840 and the handle 711 of the flush actuator 710. According to some examples, as illustrated in FIG. 19, the streaming device 840 may be configured to dispense a fluid (e.g., a cleaning fluid) and convey the fluid to the toilet using the streaming beam 841. Specifically, the dispenser 112 may be configured to dispense a cleaning fluid and a streaming beam 841 generated by the ultrasound array 10 may be configured to convey a cleaning fluid to a target surface or surfaces of the toilet 700.

For example, the streaming device 840 may be configured to dispense and convey a cleaning fluid to a target surface(s) including surface(s) of the flush actuator 710 for example surface(s) of the handle 711 of the flush actuator 710.

According to some examples, the streaming device 840 may be configured to generate a streaming beam 841 that moves over time such that a dispensed cleaning fluid may be conveyed to multiple surfaces and/or a portion of a surface or surfaces larger than a cross sectional area of the streaming beam 841.

According to some examples of the present disclosure, the cleaning fluid may be configured to disinfect the surface(s) to which it is conveyed or applied. The cleaning fluid may be nay liquid chemical, chemical compound, chemical element of combination thereof. For examples, the cleaning solution may include for example, hydrogen peroxide (H₂O₂), sodium hypochlorite (NaOCl), peroxyacetic acid, ozonated water, electrolyzed water, hypochlorous acid, or the like.

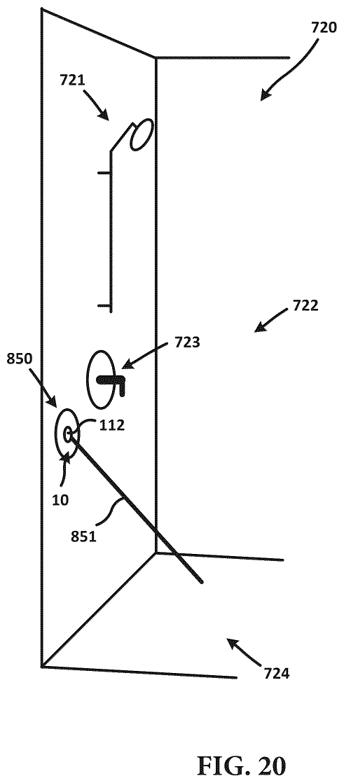

Referring to FIG. 20, a streaming device 850 is illustrated in accordance with one example of the present disclosure. The streaming device 850 may be the same or substantially similar to the streaming devices 400, 401 described above with respect to FIGS. 9 and 12. According to some examples, as illustrated in FIG. 20, the streaming device 850 may be disposed within a shower 720. For example, the streaming device 850 may be disposed proximate to a showerhead 721. According to some examples, the streaming device 850 may be disposed on a wall 722 of the shower 720. For example, the streaming device 850 may disposed on the same wall as a showerhead 721 and/or a handle 723 for controlling a flow (e.g., flow rate and/or temperature) of water dispensed from the showerhead 721.

As illustrated in FIG. 20, the streaming device 850 may include a dispenser 112 and be configured to generate a streaming beam 851 extending between the streaming device 850 and a surface or surfaces of the shower 720. According to some examples, as illustrated in FIG. 20, the streaming device 850 may be configured to dispense a fluid (e.g., a cleaning fluid) and convey the fluid to a surface of the shower 720 using the streaming beam 851. Specifically, the dispenser 112 may be configured to dispense a cleaning fluid and a streaming beam 851 generated by the ultrasound array 10 may be configured to convey a cleaning fluid to a target surface or surfaces of the shower 720. For example, the streaming device 850 may be configured to dispense and convey a cleaning fluid to a target surface(s) including the walls 722 and floor 724 of the shower 720.

According to some examples, the streaming device 850 may be configured to generate a streaming beam 851 that moves over time such that a dispensed cleaning fluid may be conveyed to multiple surfaces and/or a portion of a surface or surfaces larger than a cross sectional area of the streaming beam 851.

According to some examples of the present disclosure, the cleaning fluid may be configured to disinfect the surface(s) to which it is conveyed or applied. The cleaning fluid may be nay liquid chemical, chemical compound, chemical element of combination thereof. For examples, the cleaning solution may include for example, hydrogen peroxide (H₂O₂), sodium hypochlorite (NaOCl), peroxyacetic acid, or the like.

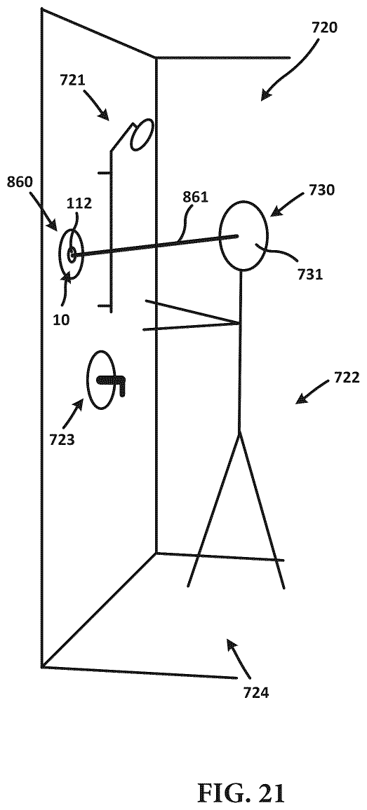

Referring to FIG. 21, a streaming device 860 is illustrated in accordance with one example of the present disclosure. The streaming device 860 may be the same or substantially similar to the streaming devices 400, 401 described above with respect to FIGS. 9 and 12. According to some examples, as illustrated in FIG. 21, the streaming device 860 may be disposed within a shower 720. For example, the streaming device 860 may be disposed proximate to a showerhead 721. According to some examples, the streaming device 860 may be disposed on a wall 722 of the shower 720. For example, the streaming device 860 may disposed on the same wall as a showerhead 721 and/or a handle 723 for controlling a flow (e.g., flow rate and/or temperature) of water dispensed from the showerhead 721.

As illustrated in FIG. 21, the streaming device 860 may include a dispenser 112 and be configured to generate a streaming beam 861 extending between the streaming device 860 and a user 730 (e.g., standing) in the shower 720. According to some examples, as illustrated in FIG. 21, the streaming device 860 may be configured to dispense a fluid (e.g., water vapor) and convey the fluid to a user and/or target anatomy 731 of a user 730 (e.g., standing in the shower 720) using the streaming beam 861. Specifically, the dispenser 112 may be configured to dispense water vapor, for example, steam and/or a cool mist and the streaming beam 861 generated by the ultrasound array 10 may be configured to convey the water vapor to a user 730 and/or target anatomy 731 of the user 730. For example, the streaming device 860 may be configured to dispense and convey water vapor to the user and/or target anatomy 731 of the user 730, for example, a face of the user 730.

According to some examples, the streaming device 860 may be configured to generate a streaming beam 861 that moves (e.g., changes orientation) such that water vapor may be conveyed to a user and/or target anatomy 731 of a user 730 that moves. According to some examples, as described in detail above, a streaming device control system 900 may include an image sensor 410 and/or proximity sensor 420 and be configured to classify objects, identify target objects (e.g., a user 730 and/or target anatomy 731), determine the orientation of a propagating axis extending between the ultrasound array 10 and the target object, and generate a streaming beam 861 along the propagating axis such that fluid (e.g., water vapor) is conveyed to the target object (e.g., user 730, target anatomy 731).

According to some examples of the present disclosure, the streaming device 860 may connected to a hot and/or cold water supply of a building (e.g., the streaming device 860 may be connected to the same hot and/or cold water supplies as a diverter of the shower 720 for controlling the temperature of water dispensed from the showerhead 721). According to some examples, the streaming device 860 (e.g., dispenser 112) may be configured to aerosolize hot water supplied by the hot water supply (e.g., so as to dispense steam). Similarly, according to some examples, the streaming device 860 (e.g., dispenser 112) may be configured to aerosolize cold water supplied by the cold water supply (e.g., so as to dispense a cool mist of water vapor).

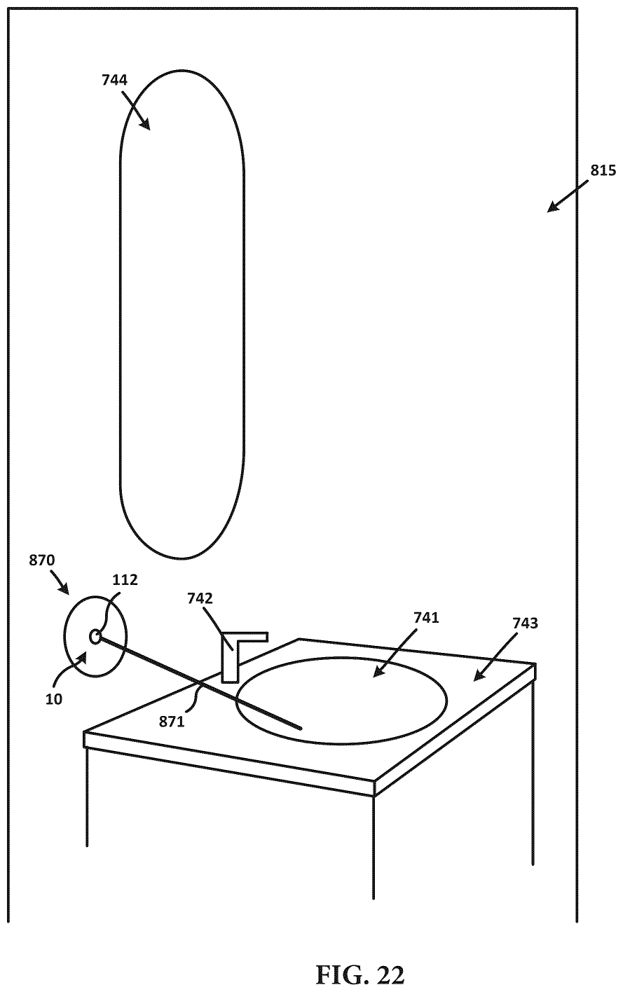

Referring to FIG. 22, a streaming device 870 is illustrated in accordance with one example of the present disclosure. The streaming device 870 may be the same or substantially similar to the streaming devices 400, 401 described above with respect to FIGS. 9 and 12. According to some examples, as illustrated in FIG. 22, the streaming device 870 may be disposed within a bathroom. For example, the streaming device 870 may be disposed proximate to a sink 741, faucet 742, countertop 743, and/or mirror 744. According to some examples, the streaming device 870 may be disposed on a wall 815 proximate to the sink 741, faucet 742, countertop 743, and/or mirror 744. For example, the streaming device 870 may be disposed on a wall 815 behind the sink 741, faucet 742, and/or countertop 743. According to some examples, the streaming device 870 may be disposed on the same wall 815 as a mirror 744.

As illustrated in FIG. 22, the streaming device 870 may include a dispenser 112 and be configured to generate a streaming beam 871 extending between the streaming device 870 and a surface or surfaces of the sink 741, faucet 742, and/or countertop 743. According to some examples, as illustrated in FIG. 22, the streaming device 870 may be configured to dispense a fluid (e.g., a cleaning fluid) and convey the fluid to a surface or surfaces of the sink 741, faucet 742, and/or countertop 743 using the streaming beam 871. Specifically, the dispenser 112 may be configured to dispense a cleaning fluid and a streaming beam 871 generated by the ultrasound array 10 may be configured to convey the cleaning fluid to a target surface or surfaces of the sink 741, faucet 742, and/or countertop 743.

According to some examples, the streaming device 870 may be configured to generate a streaming beam 871 that moves over time such that a dispensed cleaning fluid may be conveyed to multiple surfaces and/or a portion of a surface or surfaces larger than a cross sectional area of the streaming beam 871.

According to some examples of the present disclosure, the cleaning fluid may be configured to disinfect the surface(s) to which it is conveyed or applied. The cleaning fluid may be nay liquid chemical, chemical compound, chemical element of combination thereof. For examples, the cleaning solution may include for example, hydrogen peroxide (H₂O₂), sodium hypochlorite (NaOCl), peroxyacetic acid, or the like.

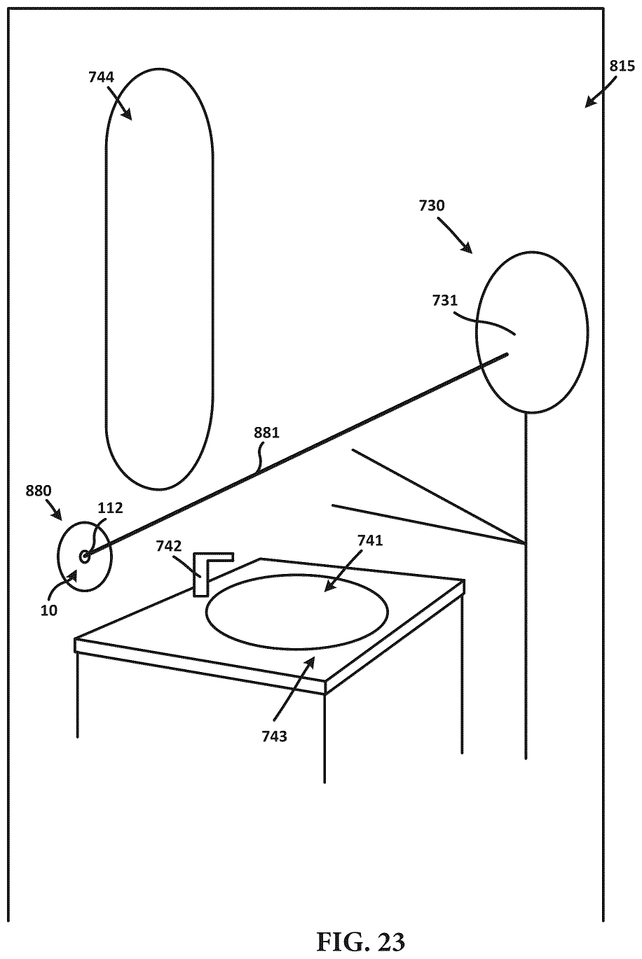

Referring to FIG. 23, a streaming device 880 is illustrated in accordance with one example of the present disclosure. The streaming device 880 may be the same or substantially similar to the streaming devices 400, 401 described above with respect to FIGS. 9 and 12. According to some examples, as illustrated in FIG. 23, the streaming device 880 may be disposed within a bathroom. For example, the streaming device 880 may be disposed proximate to a sink 741, faucet 742, countertop 743, and/or mirror 744. According to some examples, the streaming device 880 may be disposed on a wall 815 proximate to the sink 741, faucet 742, countertop 743, and/or mirror 744. For example, the streaming device 880 may be disposed on a wall 815 behind the sink 741, faucet 742, and/or countertop 743. According to some examples, the streaming device 880 may be disposed on the same wall 815 as a mirror 744.

As illustrated in FIG. 23, the streaming device 880 may include a dispenser 112 and be configured to generate a streaming beam 881 extending between the streaming device 860 and a user 730. For example, the streaming device 880 may be configured to generate a streaming beam 881 extending between the 880 and a user 730 standing in front of the sink 741, faucet 742, countertop 743, and/or mirror 744. According to some examples, as illustrated in FIG. 23, the streaming device 870 may be configured to dispense a fluid, for example, a scent, perfume, or essential oil, and convey the fluid to a user 730 and/or target anatomy 731 of a user 730 (e.g., standing in front of the sink 741, faucet 742, countertop 743, and/or mirror 744 using the streaming beam 881. Specifically, the dispenser 112 may be configured to dispense a scent, perfume, or essential oil and the streaming beam 881 generated by the ultrasound array 10 may be configured to convey the scent, perfume, or essential to the user 730 and/or target anatomy 731 of the user 730. For example, the streaming device 880 may be configured to dispense and convey a scent, perfume, or essential oil to the user 730 and/or target anatomy 731 of the user 730. The target anatomy may be for example, a face, neck, wrist, or the like of a user 730.

According to some examples, the streaming device 880 may be configured to generate a streaming beam 881 that moves (e.g., changes orientation) such that a scent, perfume, or essential oil may be conveyed to a user 730 and/or target anatomy 731 of a user 730 that moves. According to some examples, as described in detail above, a streaming device control system 900 may include an image sensor 410 and/or proximity sensor 420 and be configured to classify objects, identify target objects (e.g., a user 730 and/or target anatomy 731), determine the orientation of a propagating axis extending between the ultrasound array 10 and the target object, and generate a streaming beam 881 along the propagating axis such that fluid (e.g., a scent, perfume, or essential oil) is conveyed to the target object (e.g., user 730, target anatomy 731).

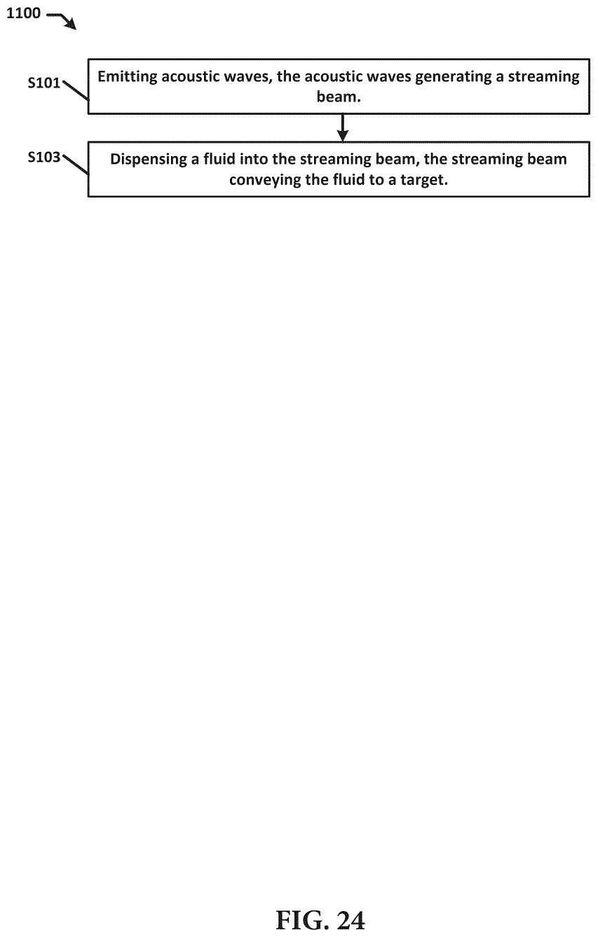

Referring to FIG. 24, a flow chart 1100 for operating a streaming device is illustrated in accordance with one example of the present disclosure. The flow chart 1100 may be used with any of the streaming devices 400, 401, 402, 810, 820, 830, 840, 850, 860, 870, 880 described herein. For ease of explanation, the flow chart 1100 is described below with respect to the streaming device 400 of FIG. 10. Additional, different, or fewer acts may be provided. The flow chart 1100 may be implemented in the order shown but may also be implemented in or according to any number of different orders.

In a first act S101, the streaming device 400 may emit acoustic waves, the acoustic waves generating a streaming beam. Specifically, an ultrasound array 10 included in the streaming device 400 may emit ultrasound waves which having collective wavefronts which are symmetrical around a propagating axis along which a streaming beam may be generated. As noted above, the ultrasound array 10 may be any of the ultrasound arrays 100, 200, 300, 350 described herein and the ultrasound array 10 may be configured to emit acoustic waves (e.g., having collective wavefronts which are symmetrical around a propagating axis) as described above with respect to any of the ultrasound arrays 100, 200, 300, 350. According to some examples, the first act S101 may including determining the location of a target object or surface (e.g., using the object classifier 932 and/or data processing module 930 as described above) and controlling (e.g., by the streaming device control system 900) the ultrasound array 10 to generate a streaming beam having an orientation or propagating angle extending between the ultrasound array 10 and the target object or surface.

In a second act S103, the streaming device 400 may dispense a fluid into the streaming beam, the streaming beam conveying the fluid to a target. Specifically, a dispenser 112 may be configured to dispense a fluid into the streaming beam. The dispenser 112 may dispense fluid in accordance with any of the above described examples. For example, the dispenser 112 may dispense any of a cleaning fluid, an air freshener, a deodorant, a scent, an essential oil, a perfume, water vapor, or the like.

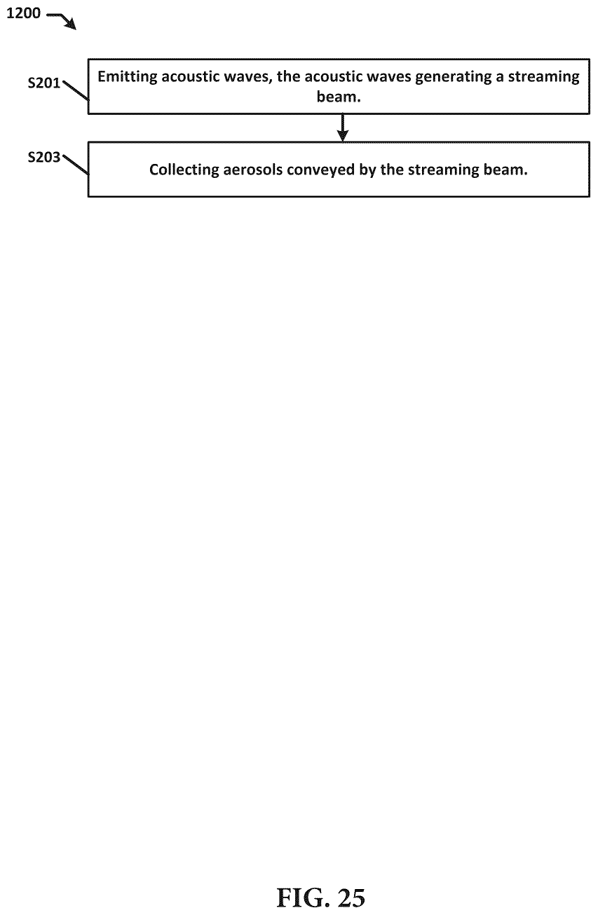

Referring to FIG. 25, a flow chart 1200 for operating a streaming device is illustrated in accordance with one example of the present disclosure. The flow chart 1200 may be used with any of the streaming devices 400, 401, 402, 810, 820, 830, 840, 850, 860, 870, 880 described herein. For ease of explanation, the flow chart 1200 is described below with respect to the streaming device 400 of FIG. 10. Additional, different, or fewer acts may be provided. The flow chart 1200 may be implemented in the order shown but may also be implemented in or according to any number of different orders.

In a first act S201, the streaming device 400 may emit acoustic waves, the acoustic waves generating a streaming beam. Specifically, an ultrasound array 10 included in the streaming device 400 may emit ultrasound waves which having collective wavefronts which are symmetrical around a propagating axis along which a streaming beam may be generated. As noted above, the ultrasound array 10 may be any of the ultrasound arrays 100, 200, 300, 350 described herein and the ultrasound array 10 may be configured to emit acoustic waves (e.g., having collective wavefronts which are symmetrical around a propagating axis) as described above with respect to any of the ultrasound arrays 100, 200, 300, 350. According to some examples, the first act S101 may including determining the location of a target object or surface (e.g., using the object classifier 932 and/or data processing module 930 as described above) and controlling (e.g., by the streaming device control system 900) the ultrasound array 10 to generate a streaming beam having an orientation or propagating angle extending between the ultrasound array 10 and the target object or surface.

In a second act S203, the streaming device 400 may collect aerosols conveyed by the streaming beam. Specifically, in some examples, the streaming beam may flow toward the streaming device 400 and a collector 113 included in the streaming device 400. In some examples, collecting the aerosols conveyed by the streaming beam may include operation of an electrostatic precipitator 118. Specifically, an electrostatic precipitator 118 may be turned on so as to ionize aerosols for collection (e.g., on a collector surface) while the ultrasound array 10 generates a streaming beam (e.g., for collecting aerosols).

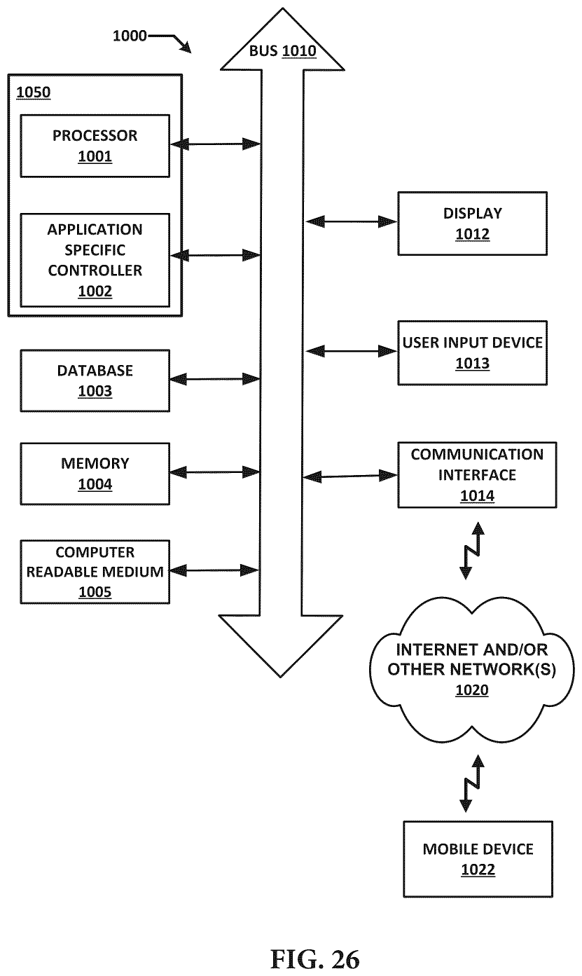

Referring to FIG. 26, an apparatus 1000 for controlling a streaming device (e.g., 400, 401, 402, 810, 820, 830, 840, 850, 860, 870, 880) in accordance with one example of the present disclosure is illustrated. In some examples, the apparatus 1000 may be implemented as the streaming device control system 900. The apparatus 1000 includes a bus 1010 facilitating communication between a controller 1050 that may be implemented by a processor 1001 and/or application specific controller 1002 and one or more components including a database 1003, a memory 1004, a computer readable medium 1005, display 1012, a user input device 1013, and a communication interface 1014.

The contents of the database 1003 may include, for example, positions of ultrasound transducers 110 included in an ultrasound array 10 (e.g., relative to a center 101 of the ultrasound array 10), one or more algorithms for determining a phase or the magnitude of a shift in phase of an ultrasound wave emitted from an ultrasound transducer 110 based on a position of the ultrasound transducer 110 and an orientation of a propagating axis along which a streaming beam is generated. The memory 1004 may be a volatile memory or a non-volatile memory. The memory 1004 may include one or more read only memory (ROM), random access memory (RAM), a flash memory, an electronic erasable program read only memory (EEPROM), or other type of memory. The memory 1004 may be removable from the apparatus 1000, such as a secure digital (SD) memory card.

The memory 1004 and/or the computer readable medium 1005 may include a set of instructions that can be executed to cause the controller to perform any one or more of the methods or computer-based functions disclosed herein. For example, the controller 1050 may send one or more controller signals and/or electric current to one or more of the ultrasound array 10, dispenser 112, and collector 113, for example, performing various acts of the flow chart 1100.

A user may select one or more target surfaces, objects, or areas using the display 1012 and/or user input device 1013. The display 1012 may comprise a screen and the user input device 1013 may comprise one or more buttons on the apparatus 1000. In some examples, the display 1012 and user input device 1013 may comprise a touch sensitive surface (i.e., a touch screen). In some examples, the user input device 1013 may include a microphone configured to receive one or more verbal or voice activation commands for controlling a streaming device (e.g., 400, 401, 402, 810, 820, 830, 840, 850, 860, 870, 880).

The communication interface 1014 may be connected to the network 1020, which may be the internet. In some examples, the network 1020 may be connected to one or more mobile devices 1022. The one or more mobile devices may be configured to send a signal to the communication interface 1014 via the network 1020. For example, one or more mobile devices may send a signal to the communication interface instructing a streaming device (e.g., 400, 401, 402, 810, 820, 830, 840, 850, 860, 870, 880) to begin generating a streaming beam.

The communication interface 1014 may include any operable connection. An operable connection may be one in which signals, physical connections and/or logical communications may be sent and/or received. An operable connection may include a physical interface, an electrical interface, and/or a data interface. The communication interface 1014 provides for wireless and/or wired communications in any known or later developed format.

When a component, device, element, or the like of the present disclosure is described as having a purpose or performing an operation, function, or the like, the component, device, or element should be considered herein as being “configured to” meet that purpose or to perform that operation or function.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. An apparatus comprising:
a dispenser configured to dispense a fluid;
an array configured to emit a plurality of acoustic waves, the acoustic waves generating a flow of air toward a target,
wherein the flow of air is configured to convey the fluid to the target.

2. The apparatus of claim 1, wherein collective wavefronts of the acoustic waves are symmetrical around a propagating axis along which the flow of air is generated.

3. The apparatus of claim 2, wherein the array further comprises:
a plurality of transducers,
wherein a phase of an acoustic wave emitted from each of the plurality of transducers is shifted proportionally to a distance between the respective transducer and a center of the array, such that the collective wavefronts of the acoustic waves are symmetrical along the propagating axis.

4. The apparatus of claim 2, wherein the array further comprises:
a plurality of transducers arranged in a plurality of rings around a center of the array, wherein each transducer include in a respective ring is disposed the same distance away from the center of the array.

5. The apparatus of claim 4, wherein acoustic waves of the plurality of acoustic waves having the same phase are emitted from each transducer included in a respective ring of the plurality of rings.

6. The apparatus of claim 2, wherein the array comprises:
a plurality of transducers,
wherein each of the transducers is offset from a primary plane along which the array is arranged a distance proportional to a distance along the primary plane between the respective transducer and a center of the array, such that the collective wavefronts of the acoustic waves are symmetrical along the propagating axis.

7. The apparatus of claim 1, wherein the array further comprises:
a plurality of tuning bricks configured to receive the plurality of acoustic waves and shift a phase of the plurality of acoustic waves, such that collective wavefronts of the plurality of acoustic waves having traveled through the plurality of tuning bricks are symmetrical around a propagating axis along which the flow of air is generated.

8. The apparatus of claim 1, wherein the dispenser is disposed at a center of the array.

9. The apparatus of claim 1, wherein the fluid is a cleaning fluid and the target is a surface of a toilet, a surface of a shower, a faucet, a sink, or a counter top.

10. An apparatus comprising:
a collector;
an array configured to emit a plurality of acoustic waves, the acoustic waves generating a flow of air toward the collector,
wherein the flow of air is configured to convey aerosolized particles to the collector.

11. The apparatus of claim 10, wherein collective wavefronts of the acoustic waves are symmetrical around a propagating axis along which the flow of air is generated.

12. The apparatus of claim 11, wherein the array further comprises:
a plurality of transducers,
wherein a phase of an acoustic wave emitted from each of the plurality of transducers is shifted proportionally to a distance between the respective transducer and a center of the array, such that the collective wavefronts of the acoustic waves are symmetrical along the propagating axis.

13. The apparatus of claim 11, wherein the array further comprises:
a plurality of transducers arranged in a plurality of rings around a center of the array, wherein each transducer include in a respective ring is disposed the same distance away from the center of the array.

14. The apparatus of claim 13, wherein acoustic waves of the plurality of acoustic waves having the same phase are emitted from each transducer included in a respective ring of the plurality of rings.

15. The apparatus of claim 11, wherein the array comprises:
a plurality of transducers,
wherein each of the transducers is offset from a primary plane along which the array is arranged a distance proportional to a distance along the primary plane between the respective transducer and a center of the array, such that the collective wavefronts of the acoustic waves are symmetrical along the propagating axis.

16. The apparatus of claim 11, wherein the array further comprises:
a plurality of tuning bricks configured to receive the plurality of acoustic waves and shift a phase of the plurality of acoustic waves, such that collective wavefronts of the plurality of acoustic waves having traveled through the plurality of tuning bricks are symmetrical around a propagating axis along which the flow of air is generated.

17. A method for conveying fluids, the method comprising:
emitting, by a sound source, a plurality of acoustic waves, the plurality of acoustic waves generating a streaming beam;
dispensing, by a dispenser, a fluid into the streaming beam such that the fluid is conveyed by the streaming beam to a target.

18. The method of claim 17, wherein the emitting further comprises emitting acoustic waves having collective wavefronts which are symmetrical around a propagating axis along which the streaming beam flows.

19. The method of claim 18, wherein the sound source comprises an array of transducers further comprising:
shifting a phase of an acoustic wave of the plurality of acoustic waves emitted from a transducer of the array of transducers proportionally to a distance between the respective transducer and a center of the array of transducers.

20. The method of claim 19, further comprising:
receiving, by a processor, image data from an image sensor;
analyzing, by the processor, the image data to assign a classification to an object included in the image data; and
determining the orientation of the propagating axis based on the assigned classification.
